(19) United States
(12) Patent Application Publication
(10) Pub. No.: US 2003/0068824 A1
(43) Pub. Date: Apr. 10, 2003

(54) CORROSION-SENSING COMPOSITION AND METHOD OF USE

(76) Inventors: GERALD S. FRANKEL, BEXLEY, OH (US); RUDOPH G. BUCHHEIT, COLUMBUS, OH (US); JIAN ZHANG, COLUMBUS, OH (US)

Correspondence Address: STANDLEY & GILCREST LLP, 495 METRO PLACE SOUTH, SUITE 210, DUBLIN, OH, 43017, US

(21) Appl. No.: 09/467,719

(22) Filed: Dec. 21, 1999

(51) Int. Cl. G01N 31/00

(52) U.S. Cl. 436/60

(57) ABSTRACT

The corrosion sensing or detecting composition and method of the present invention preferably includes an aqueous gel that is adapted as a temporary coating for a surface of a material and that includes at least one composition that changes its appearance in response to corrosion occurring on the surface of the material. In a variation of the preferred embodiment, the at least one composition is further adapted to change color in response to a change in hydrogen ion concentration proximate to the surface of the material. The present invention is also directed to a vehicle, such as an aircraft, a spacecraft, an automotive vehicle, an amphibious vehicle, a boat, and a ship, that is prepared for corrosion inspection. The vehicle and method for inspecting the vehicle preferably include a painted material surface with the paint removed for application of a removable corrosion-detecting coating that changes its appearance in response to corrosion occurring on the surface. In variations of the coating, the corrosion-detecting substance includes an aqueous gel formulated with at least one composition that changes its appearance in response to corrosion occurring on the material surface. The at least one composition may further be selected from the group consisting of substances that change color in response to a change in hydrogen ion concentration proximate to the material surface of the vehicle. Still other variations include corrosion detecting paints that change color in response to corrosion on the material surface.

This invention was made with U.S. Government support under Contract Grant No. F49620-96-1-0042 awarded by the Wright Patterson Air Force Base Materials Directorate through The Air Force Office of Scientific Research of the United States Air Force. Accordingly, the U.S. Government has certain rights in this invention.

### BACKGROUND OF THE INVENTION

1. Technical Field of the Invention

The present invention is directed to permanent and temporary coatings for sensing oxidative dissolution corrosion of metal structures.

2. Background

The early detection of corrosion in complex metallic structures and vehicles is an extremely time-consuming, resource intensive, and difficult task that implicates significant economic and safety considerations. For example, automotive vehicles, spacecraft, watercraft, and complex military and commercial aircraft weighing upwards of 250,000 pounds are fabricated from millions of parts that are fastened together with a myriad of different types of fasteners and fastening techniques. More specifically, as an example of one type of vehicle, aircraft structures include all types of compression, tension, and shear joints that fasten together structural components such as longerons, stringers, pylons, and skins, to name a few, as well as a host of other aircraft components. The joints are typically created using, for example, welds, rivets, screws, bolts, and adhesives, among other types and sub-types of fasteners. Since a thin-walled skin typically covers a majority of the exterior of the aircraft, most of the structural components, joints, and fasteners are located in generally inaccessible locations that, even with the skin removed for inspection, are difficult to observe for purposes of visually detecting corrosion and related structural degradation.

As a result, the early detection of corrosion by visual inspection in hidden spaces and buried crevices is difficult at best and impossible at worst. The personnel responsible for the inspection and detection of corrosion on military and commercial aircraft are forced to spend enormous amounts of time and huge sums of money on finding and combating corrosion. In recent years, the United States Department of Defense alone spends about $3 billion each year on synchronal inspections and corrective measures directed to fighting aircraft corrosion. As a result, many different types of sensors and techniques have been and are being developed to facilitate the early detection of corrosion. However, past and present sensors and techniques are only effective if they are either physically applied to the location on the vehicle or aircraft where the corrosion is occurring, or if the sensors are sensitive and responsive to provide indications that corrosion is occurring in remote, generally inaccessible locations on the aircraft. Furthermore, such sensors must be inexpensive to formulate and apply to the aircraft and easy to use for detecting corrosion.

Military and commercial aircraft undergo routine pre-flight, post-flight, and periodic corrosion inspections and corrective maintenance at both local military bases and airports. Also, far more extensive and comprehensive inspections and corrective measures are accomplished periodically at military and commercial depot maintenance centers located in several key regions across the country. While the local routine inspections and maintenance activities can last from minutes to a few weeks, the more comprehensive inspection and maintenance procedures can last from 3 months up to 18 months, or more, and can effectively recondition the airplane. Sites on the planes that are known by experience to be susceptible to corrosion are carefully examined during the more comprehensive efforts. However, it is impossible to closely inspect every generally inaccessible hidden space, joint, and crevice on an aircraft having hundreds if not thousands of such locations and structures. Very expensive and time-consuming techniques, such as x-ray radiography, ultrasonic imaging, and electromagnetic eddy current inspection methods can be employed for the more difficult to see regions.

Inspectors and maintainers can typically spot obvious corrosion attack such as, for example, corrosion occurring on exterior skins, which can often result in separation of paint and undercoating from the skin surface, and in skin lap joints, which in an advanced state results in what is sometimes referred to as “pillowing.” See, for example, D. Groner, in 38^{th} AIAA/ASME/ASCE/AHS/ASC. Structures, Structural Dynamics, and Materials Conference and Exhibit, April 7-10, Kissimmee, Fla. (1997). While such obvious instances of corrosion can be corrected, much of the corrosion on aircraft structures goes unnoticed. Thus, most sites of such corrosion attack continue to deteriorate and may even propagate to extended or new areas of the aircraft. Unchecked corrosion results in increased safety concerns and the need for more extensive correction and maintenance procedures that might have been avoided altogether if earlier detection was attainable. Therefore, it can be understood that it is very important for aircraft maintenance workers to know where corrosion exists on an aircraft so that appropriate and immediate remedial measures can be implemented.

In the past, various approaches have been employed and sensors have been developed to detect hard to find corrosion of metallic structures including the use of a coating applied to the surface of the structure to sense the corrosion. The approach has been attempted for various types of structures and the prior art coatings have been intended to act as a sensor reactive to corrosion. See, for example, A. Pourbaix, AGARD Conference Proc., Paper No. 12, CP 0549-7191, 565 (1995), V. S. Agarwala and A. Fabiszewski, Corrosion 94 Paper No. 342, NACE International, Houston, Tex. (1994), and W. Podney, Rev. Prog. Quant. Nondestructive Eval., D. O. Thompson and D. E. Chimenti, Editors, 13, New York, Plenum Press, p. 1947 (1994). Others have pursued approaches that include use of color-change pH indicators that have been incorporated into organic coatings for determining the pH gradients associated with corrosion such as filiform beads. See, for example, G. M. Hoch, Localized Corrosion, NACE-3. R. W. Staehle, B. F. Brown, J. Kruger, A. Agrawal, Eds., NACE International, Houston (1974). Fluorescent dyes have also been applied to microelectronic test vehicles to detect pH changes associated with corrosion of aluminum or gold metallization under an applied electrical bias in a humid environment. See, for example, L. White, J. Electrochem. Soc., 128, 953 (1981). Other attempts have included the use of fluorescing and color-change dyes that have been applied to aluminum after corrosion in order to identify the locations of the hydrous aluminum oxide corrosion product. See, for example, N. Cippolini, J.Electrochem.Soc., 129, 1517 (1982). More recently, paint has been formulated to include different chemicals that fluoresce upon oxidation or upon complexation with metal cations formed by the corrosion process. See, R. E. Johnson and V. S. Agarwala, Corrosion 97, Paper No. 304, NACE International, Houston, Tex. (1997), and R. E. Johnson and V. S. Agarwala, Mat. Perf., 33, 25-29 (1994).

The entire preceding discussion also applies to structures other than aircraft, including without limitation, all types of land, water, space, and air craft as well as buildings, bridges, cranes, land and sea-based oil platforms and drillings rigs, motorcycles, automobiles, and trucks, and nearly every type of structure or vehicle that is subject to corrosion. While much of the previous discussion centers around the aluminum and steel structures commonly associated with military and civilian aircraft construction, the same corrosion problems also present themselves for all types of metallic structures. Accordingly, what has been needed but heretofore unavailable is a less-expensive and more comprehensive technique for visually revealing locations of corrosion, even in difficult to inspect locations.

### SUMMARY OF THE INVENTION

The corrosion sensing or detecting composition of the present invention overcomes many of the shortcomings of the prior art technology of detecting corrosion. The composition for detecting corrosion of a material surface preferably includes an aqueous gel that is adapted as a coating for a surface of a material and that includes at least one composition that changes its appearance in response to corrosion occurring on the surface of the material. In a variation of the preferred embodiment, the at least one composition is further adapted to change color in response to a change in hydrogen ion concentration proximate to the surface of the material.

The present invention is also directed to a vehicle, such as an aircraft, a spacecraft, an automotive vehicle, an amphibious vehicle, a boat, and a ship, that is prepared for corrosion inspection. The vehicle preferably includes a material surface that has been coated with a removable corrosion-detecting substance that changes its appearance in response to corrosion occurring on the surface. In variations of the coating, the corrosion-detecting substance includes an aqueous gel formulated with at least one composition that changes its appearance in response to corrosion occurring on the material surface. The at least one composition may further be selected from the group consisting of substances that change color in response to a change in hydrogen ion concentration proximate to the material surface of the vehicle.

A method of detecting corrosion of a material surface is also contemplated by the present invention. The method includes the steps of selecting a material having a surface subject to corrosion, applying to the surface a removable corrosion-detecting substance that changes its appearance in response to corrosion occurring on the surface of the material, and determining whether the appearance of the substance changed so as to indicate the presence of corrosion. Additionally, the method also preferably includes the steps of removing the substance from the surface after the corrosion detection step. In variations of the preferred embodiment of the method of detecting corrosion, a material is selected that includes a coated surface that is subject to corrosion. After the coating has been removed from the surface, corrosion is detected by applying to the surface a removable corrosion-detecting substance that changes its appearance in response to corrosion occurring on the surface of the coated material. Next, it is determined whether the appearance of the substance changed so as to indicate the presence of corrosion. After the determination is made, the substance is removed from the surface. In the preferred practice of the method of the present invention, the corrosion-detecting substance incorporates an aqueous gel that includes at least one composition that changes its appearance in response to corrosion occurring on the surface of the material. Additionally, in variants of the present method, the at least one composition is selected from the group consisting of substances adapted to change color in response to a change in hydrogen ion concentration proximate to the surface of the material. If desired, the coating can be reapplied to the surface following removal of the corrosion detecting substance.

In other variations of any of the preceding variations of the preferred embodiment of the present invention, the coating can be a paint. In alternative methods practicing the present invention an aircraft is selected that has a surface subject to corrosion and bearing a coating. First, the coating is removed from the surface and then the surface is covered with a removable corrosion-detecting substance that changes its appearance in response to corrosion occurring on the surface. Next, a determination is made whether the appearance of the substance changed its appearance so as to indicate the presence of corrosion. Once the determination has been made, the substance is removed from the surface. In modifications to the present method, the corrosion-detecting substance incorporates an aqueous gel that includes at least one composition adapted to change its appearance in response to corrosion occurring on the surface. The at least one composition is preferably selected from the group consisting of substances adapted to change color in response to a change in hydrogen ion concentration proximate to the surface. Also, the step of reapplying the coating to the surface following removal of the corrosion detecting substance from the surface can also be included in practice of the present method. Further, the coating in any of the preceding variations can be a paint.

### DESCRIPTION OF THE DRAWINGS

The file of this patent contains color drawings. Copies of this patent with color drawings will be provided by the Patent and Trademark Office upon request and payment of the necessary fee.

Without limiting the scope of the present invention as claimed below and referring now to the drawings, wherein like reference numerals across the several views refer to identical, corresponding, or equivalent parts:

FIG. 1 is a chart that compares the alkaline form of various color changing pH indicators versus the pH range of the indicator for various pH indicating compositions;

FIG. 2 is cross-sectional view, in enlarged scale, of a painted aircraft lap joint crevice undergoing anodic and cathodic corrosion;

FIG. 3 depicts a cross-sectional schematic view, in enlarged scale, of the structure of a pH-indicating coating according to the present invention;

FIG. 4(a) is a color photograph of a cross-section of an aluminum 5454 alloy that has been coated with a color-responsive, pH-indicating acrylic phenolphthalein paint and then immersed for 8 days in a 1.0 molar sodium-chloride bath;

FIG. 4(b) is a color photograph of a cross-section of an aluminum 5454 alloy that has been coated with a color-responsive, pH-indicating acrylic bromothymol paint and then immersed for 13 days in a 1.0 molar sodium-chloride bath;

FIG. 4(c) is a color photograph of a cross-section of an aluminum 2024 alloy that is coated with a color-responsive, pH-indicating acrylic coating, which has an initial red color, and that has been modified by phenolphthalein at about 2.4 percent by weight;

FIG. 4(d) is a color photograph, in enlarged scale, of the photograph of FIG. 4(c);

FIG. 5(a) is a color photograph, in enlarged scale, of a cross-section of an aluminum 2024-T3 alloy coated with an acrylic formulated with a phenophthalein of about 2.4 percent by weight after immersion in a 1 molar sodium-chloride bath for about 4 hours;

FIG. 5(b) is a color photograph, in enlarged scale, of the cross-section of the aluminum 2024-T3 alloy of FIG. 5(a) after about 9 hours;

FIG. 5(c) is a color photograph, in enlarged scale, of the cross-section of the aluminum 2024-T3 alloy of FIG. 5(a) after about 8 days;

FIG. 6(a) is a color photograph, in enlarged scale, of a highly polished cross-section of an aluminum 2024-T3 alloy coated with an acrylic formulated with a phenophthalein of about 2.4 percent by weight after immersion in a 1 molar sodium-chloride bath for about 20 minutes;

FIG. 6(b) is a color photograph, in enlarged scale, of the cross-section of the aluminum 2024-T3 alloy of FIG. 6(a) after about 1 hour;

FIG. 7(a) is an atomic force microscopy (“AFM”) topographic map for an aluminum 2024-T3 alloy sample coated with a layer about 20 to 30 μm thick of an acrylic formulated with a phenophthalein of about 2.4 percent by weight after immersion in a 1 molar sodium-chloride bath;

FIG. 7(b) is a line scan of the AFM topographic map of the sample of FIG. 7(a);

FIG. 8 is a schematic drawing, in reduced scale, of an artificial crevice assembly adapted to test the corrosion sensing coatings of the present invention;

FIG. 9 is a color photograph of an artificial crevice assembly including a sample coated with an acrylic coating, which has an additive of about 2.4% by weight (“% wt.”) of phenolphthalein, after a constant potential of 500 mV has been applied for 26 hours while immersed in a 1.0 molar sodium chloride bath;

FIG. 10 is a chart that depicts the sensitivity of clear and 1200 acrylic based pH-indicating coatings that are applied to a T3 temper 2024 aluminum alloy that has been immersed in a 0° C., 1.0 molar sodium chloride bath, the chart plots the time in hours for an initial color change at of the phenolphthalein coating versus the percent by weight of the phenolphthalein content relative to the coating;

FIG. 11 is a chart that depicts the detection time for initial color change versus a series of applied constant cathodic current densities from 0.01-50 μA/cm² for an Aluminum 2024 alloy of the type illustrated in FIG. 2 that have been coated with an acrylic phenolphthalein coating and immersed in a 1.0 molar sodium-chloride bath;

FIG. 12 is a chart that depicts the relationship between the time required for detection of corrosion versus the surface area of a specimen of an aluminum 2024 alloy that is coated with an acrylic, which has an additive of about 2.4% wt. of phenolphthalein, while immersed in a 1.0 molar sodium chloride bath and exposed to a constant current density of 5 μA/cm²;

FIG. 13 is a chart that compares the experimental and expected relationships between the time required for detection of corrosion using the color-changing acrylic coating, which has a phenolphthalein additive of about 2.4% wt., and the area of the sample of aluminum 2024 alloy subjected to an applied cathodic constant current of 5 μA;

FIG. 14 is a logarithmic chart that represents the linear relationship between the time/number of samples and the current in microamperes passed through the corrosion sensing sample coated with the color-changing acrylic coating described and referred in FIGS. 9 through 11;

FIG. 15 is a chart that describes the sensitivity of a coating by open circuit immersion and galvanostatic testing for an aluminum 2024-T3 alloy coated with a either a clear of 1200 acrylic base, and that plots the time of initial color change or fluorescence when the 2024-T3 alloy is immersed in a zero degree bath of 1 molar sodium chloride against the effective pit radius in micrometers;

FIG. 16 is a schematic diagram of an equivalent circuit used for EIS data analysis;

FIG. 17 is a chart that presents a Bode plot of resistance and phase angle plotted against the frequency of the biasing current as determined by periodic electrochemical impedance spectroscopy (“EIS”) measurements of an aluminum 2024-T3 alloy sample that is coated with a 1200 acrylic base having phenolphthalein added in the amount of about 1.0% wt. for different immersion times in a 1.0 molar sodium chloride bath;

FIG. 18 is a chart describing the relationship between corrosion sensing sensitivity and coating polymer properties as a function of coating pore percentage, color change over time, and low frequency impedance in ohms per square centimeter;

FIG. 19 is an environmental scanning electron microscopy (“ESEM”) image, magnified 400 times, of a pure agar based gel coating (without indicators or NaCl) 4 hours after application on a glass slide;

FIG. 20 is an ESEM image, magnified 400 times, of sample A2 (See Table 4, Sample A2) 4 hours after application on a glass slide;

FIG. 21(a) is an ESEM image, magnified 2000 times, of the slide-mounted sample A2 shown in FIG. 20;

FIG. 21(b) is an ESEM image, magnified 3200 times, of the slide-mounted sample A2 shown in FIG. 20;

FIG. 22 is a chart describing the relationship between the immersion time of a sample of aluminum alloy 2024-T3 in a 1 M NaCl bath and the time required for appearance of a change in color of a gel coating on the samples that includes 0.49% wt. agar and 0.24% wt. phenolphthalein;

FIG. 23 is a chart describing the relationship between the immersion time of samples of aluminum alloy 2024-T3 in a 1 M NaCl bath and the time required for appearance of a change in color of a gel coating on the samples that includes 0.49% wt. agar and 0.05% wt. phenolphthalein;

FIG. 24 is a chart describing the relationship between the immersion time of samples of aluminum alloy 2024-T3 in a 1 M NaCl bath and the time required for appearance of a change in color of a gel coating on the samples that includes 0.49% wt. agar, 0.05% wt. phenolphthalein, and 1.7% wt. NaCl;

FIG. 25 is a chart describing the relationship between the immersion time of samples of aluminum alloy 2024-T3 in a 1 M NaCl bath and the time required for appearance of a change in color of a gel coating on the samples that includes 0.49% wt. agar, 0.24% wt. phenolphthalein, and 1.7% wt. NaCl;

FIG. 26(a) is a color photograph of a cross-section of an aluminum alloy 2024-T3 sample mounted in an epoxy substrate that has been polished using a 600 grit, water-based abrasive;

FIG. 26(b) is a color photograph of the sample of FIG. 26(a), magnified about 10 times;

FIG. 27(a) is a color photograph of a cross-section of an aluminum alloy 2024-T3 sample mounted in an epoxy substrate that has been polished with a 600 grit, water-based abrasive and coated with a pH sensing, color changing, modified agar-gel, that includes 0.49% wt. agar, 0.24% wt. phenolphthalein, and 1.7% wt. NaCl, after 5 hours exposure to the ambient environment;

FIG. 27(b) is a color photograph of the sample of FIG. 27(a), magnified about 10 times;

FIG. 28(a) is a color photograph of the sample of FIG. 27(a) wherein the gel has been washed off of the sample surface;

FIG. 28(b) is a color photograph of the sample of FIG. 28(a), magnified about 10 times;

FIG. 29 is a color photograph of a cross-section of an aluminum alloy 2024-T3 sample mounted in an epoxy substrate that has been polished, immersed in a 1M NaCl solution for 14 minutes, and coated with a pH sensing, color changing, modified agar-gel, that includes 0.49% wt. agar, 0.24% wt. phenolphthalein, and 1.7% wt. NaCl, after 4 hours exposure to the ambient environment;

FIG. 30(a) is a color photograph of the sample of FIG. 29, wherein the gel coating was washed off after 10 hours;

FIG. 30(b) is a color photograph of the sample of FIG. 30(a), magnified about 4.3 times and including the region surrounded by the black dashed lines of FIG. 30(a);

FIG. 30(c) is a color photograph of the sample of FIG. 30(a), magnified about 10 times and including the region surrounded by the white dashed lines of FIG. 30(b);

FIG. 31 is a chart describing the relationship between the time of initial color change (“TICC”) of a modified agar-gel containing coating that includes 0.49% wt. agar, 0.24% wt. phenolphthalein, and the magnitude of a cathodic charge applied to an aluminum alloy 2024-T3 sample before application of the gel coating;

FIG. 32 is a color photograph of a cross-section of the sample of FIG. 29 at a region where the sample meets the edge of the mounting epoxy substrate and showing the pH sensing color change 4 hours after the modified agar-gel coating was applied to the sample;

FIG. 33(a) is a chart that describes the relationship between the temperature at which the agar-gel coating gels, and the relative concentration of the agar contained in the gel coating, for various species of red algae; and

FIG. 33(b) is a chart that describes the relationship between the temperature at which the agar-gel coating melts, and the relative concentration of the agar contained in the gel coating, for various species of red algae.

### DETAILED DESCRIPTION OF THE PREFERRED EMBODIMENTS

The following is a detailed description of a preferred embodiment of the proposed invention that is also considered to be the best mode. Two different approaches to corrosion sensing for complex structures are contemplated by the present invention. Both rely on the application of a coating to sense the corrosion. The approach is as effective for aircraft structures, as it is for other vehicles and structures susceptible to corrosion including spacecraft, automotive vehicles, amphibious vehicles, boats, and ships. The coating to be used as a sensor reacts to local corrosion processes. Corrosion is an oxidative dissolution process whereby metal atoms lose electrons and are transformed into an ionic species stoichiometrically represented by Equation (1):

M→Mⁿ⁺+ne⁻ (1)

As mentioned above, this reaction often takes place in inaccessible crevices for complex structures fabricated from engineering materials that are susceptible to localized corrosion. Localized corrosion of materials such as aluminum alloys (“AA”) and stainless steels (“SS”) occurs in the form of crevices or pits. The dissolution reaction shown in Equation (1) is not easily detected because it typically occurs in remote locations. That is the essence of the corrosion detection problem. The basic idea of this invention is to use a coating that senses the cathodic reaction that accompanies the oxidative corrosion reaction. The oxidation reaction in Equation (1) cannot occur alone since that would result in the production of electrons. Conservation of charge is a fundamental physical principle. Oxidation reactions must be accompanied by reduction reactions that consume the electrons. The main cathodic reaction for any form of atmospheric corrosion is oxygen reduction and is chemically represented by Equation (2):

O₂+2H₂O+4e⁻→4OH⁻ (2)

Equations (3) and (4) represent the other cathodic reactions that often accompany corrosion and which are commonly referred to as hydrogen evolution:

2H⁺+2e³¹ →H₂ (3)

or

2H₂O+2e³¹ →H₂+2OH⁻ (4)

For localized corrosion such as pitting, crevice, and exfoliation corrosion, the cathodic reaction will tend to occur at more-accessible locations than the anodic reaction, i.e. nearer to the source of oxygen or water in the environment. All of these cathodic reactions will cause an increase in the local pH at the location where they occur. Therefore, a coating that is sensitive to pH increases generated by the cathodic reaction will indirectly be sensing corrosion occurring nearby. Those with skill in the art recognize “pH” as the widely used acronym that represents the phrase “potential of hydrogen.” pH is a measure of the acidity or alkalinity of a solution, which is numerically equal to 7 for neutral solutions, and which increases with increasing alkalinity and decreases with increasing acidity. The pH scale in most commonly used ranges from 0 to 14. The pH value is the negative common logarithm of the hydrogen-ion concentration in a solution, which is expressed in moles per liter of solution. A neutral solution, i.e., one that is neither acidic nor alkaline, such as pure water, has a concentration of 10⁻⁷ moles per liter. Thus, its pH is 7. Acidic solutions have pH values ranging with decreasing acidity from about 0 to about 7. Alkaline or basic solutions have a pH ranging with increasing alkalinity from just greater than about 7 to about 14.

The present invention is directed to two variations of the preferred embodiment. In the first variation, a paint primer layer is used, in a total vehicle paint system, that is modified to make it sensitive to local pH changes for detecting corrosion on a material surface of a vehicle. The modified paint primer incorporates at least one pH sensing composition or compound that is mixed into the primer or that is chemically bound to the polymeric chains in the paint primer resin. The pH-corrosion sensing compounds can be either color-changing or fluorescing compounds having critical pH values in the slightly alkaline region, for example, between approximately pH 8-10. The primer-based sensing system is intended to be applied for future use after a plane has been totally reconditioned and all corrosion has been eliminated. A paint system incorporating these types of pH-corrosion sensing compositions can be adapted so that they need not be removed for the remaining life of the vehicle.

In practice, current aircraft primers preferably incorporate epoxy polyamide resins. Such resins necessitate the use of alkaline amine hardeners. Typically, the residual hardener that remains after curing results in a local environment that is moderately alkaline. The alkalinity interferes with the approach of the present for detecting small pH increases resulting from local cathodic reactions that are prevalent when corrosion occurs. The inventors have found that it is possible to avoid this problem by neutralizing the resin/hardener mixture with organic acids such as citric or acetic acid before the epoxy has a chance to harden. Neutralized epoxies mixed with pH indicators have been found to be sensitive to small pH changes.

The second variation of the preferred embodiment of the invention is a corrosion-sensing coating that is only temporarily applied to a surface of a vehicle for purposes of detecting corrosion and an increase in pH. This embodiment is important to address needs of detecting corrosion in aging vehicle structures including, for example, aircraft in depot maintenance. Currently, the paint is stripped from the exterior of a plane during maintenance in order to facilitate the inspection process. Even with the paint removed, however, the sites of localized corrosion are not readily evident. The idea here is to apply a temporary coating that would sense the locations of the localized corrosion processes. The locations would be recorded, and the sensing coating would be removed.

The requirements for this second variation of the preferred embodiment are that the coating be must removable without undue burden. Also, after application to the vehicle surface, the coating should be able to quickly, if not instantly, indicate the location of existing corrosion. The removal characteristic is satisfied by the use of either an aqueous or gelatinous coating, which could be easily washed off, or an applique formulated to have poor adhesion for ease of removal. The sensitivity requirement would necessitate the use of a pH indicator with a critical pH close to neutral. The fluorescing compound 7-hydroxycoumarin has been found to be suitable for purposes of the present invention. See, for example, Encyclopedia of Analytical Science, A. Townshend, Ed., Academic Press, London (1995), and J. Zhang and G. S. Frankel, “Paint as a Corrosion Sensor; Acrylic Coating Systems,” in MRS Symposium Proceedings entitled “Nondestructive Characterization of Materials in Aging Systems,” R. Crane, J. Achenbach, S. Shah, T. Matikas, and P. Khuri-Yakub, eds., p15-24, Volume 503, The Material Research Society, Warrendale, Pa., 1998.

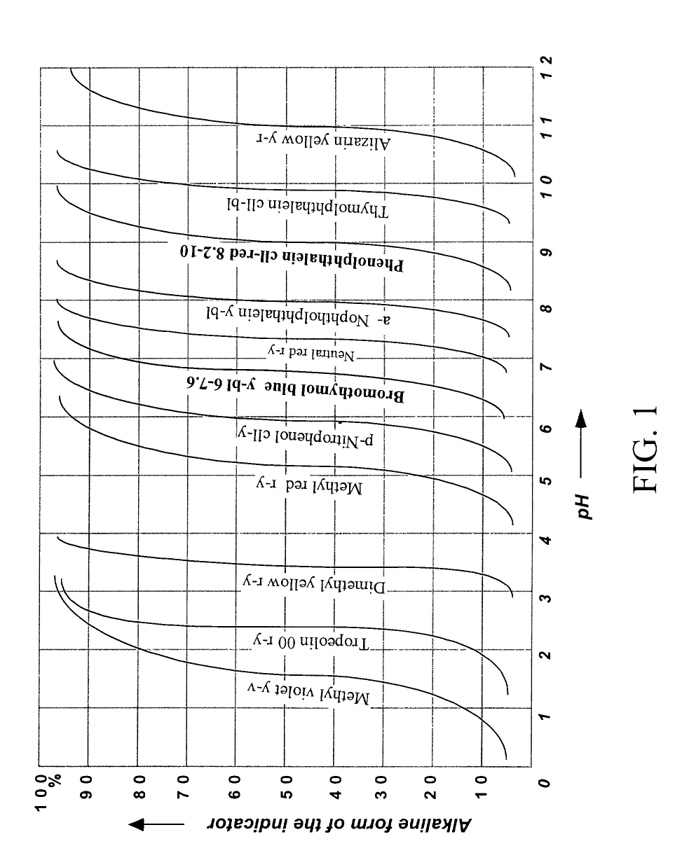

For purposes of the present invention in all of its embodiments and variations, many types of color changing pH indicators are commercially available. The color change range of some of the more commonly used pH indicators are represented in the graph of FIG. 1.

Although acrylic resins were used by the inventors to establish the viability of the present invention, they are not protective enough to be used as a primer for aircraft, and they are too adherent to be used as a temporary coating. However, acrylic provides a suitable matrix to demonstrate the operability of the present invention. The sensitivity of acrylic-based coating systems for detection of cathodic reactions associated with corrosion is determined by applying constant cathodic current and measuring the charge at which color change or fluorescence is detected on a sample of a vehicle material surface. Visual observation of coated samples using the unaided eye can detect color changes resulting from a corrosion induced elevation in the pH of the local surface. The pH change is associated with the change in local galvanic charge corresponding to a hemispherical pit in the material surface having a depth on the order of approximately 10 μm. The characteristics of modified acrylic coating systems were studied by using titration tests. Electrochemical Impedance Spectroscopy (“EIS”) was also performed to test the influence of the addition of a pH-corrosion sensing, color change indicator compound to the acrylic coating system on the coating corrosion protectiveness. These tests determined that the time for color change was controlled by the sensitivity of the coating to pH increase, and not by the coating protectiveness. Additional testing determined that color change indicators such as phenolphthalein, which has a color change critical pH of about 10, would also be suitable for incorporation into a permanent primer. The fluorescing compound 7-hydroxycoumarin, which has a critical pH of about 8, would be suitable for use in a temporary corrosion-sensing compound because it is much more sensitive.

For purposes of illustrating a vehicle structure susceptible to corrosion, a schematic representation is described in FIG. 2 of a typical, difficult to inspect aircraft skin-to-skin lap joint 10. The lap joint 10 includes two skin sections 20 joined by a rivet 25. The bonded skin sections 20 can be fabricated from an aluminum alloy (“AA”) such as 2024 in the T3 temper condition. These skin sections may be coated with an exterior protective paint or a corrosion preventative paint or coating 30, or both, that has developed defects or cracks 35. The defects 35 in the coating 30 are the result of improper paint application, flexing of the vehicle skin structure during operation, impact abrasion, improper paint curing, or a combination thereof, and normal degradation and wear and tear. These effect are experienced over the life of all vehicle coatings and result from exposure to the environment and operational conditions. Localized cathodic corrosion often occurs at locations 40 proximate to the defect 35 while remote anodic corrosion occurs at locations 45 distal to the defects 35, as a result of conversation of charge principles. That is, the defect induced cathodic reactions create the opportunity for corresponding anodic corrosion elsewhere. Thus, one having ordinary skill in the art can begin to appreciate from the preceding discussion with reference to FIG. 2 that while the localized cathodic reaction, if intense enough, could result in cathodic corrosion that might be visually detectable with the unaided eye after the coating 30 has been removed from the skins 20. Furthermore, the remote anodic corrosion would remain undetectable visually unless the extraordinary effort is undertaken to disassemble the lap joint 10. The detection scheme of the present invention enables easy and sensitive visualization of the cathodic reaction associated with corrosion.

Accordingly, it can also be appreciated that the pH-corrosion detecting, color-changing composition of the present invention must be formulated so that it senses corrosion remote from the location of the applied composition. Such remote corrosion can occur deep inside lap joints and other hidden or remote locations on the vehicle structure. Additionally, the composition must sense localized corrosion immediately proximate to the corrosion sensing coating. Both capabilities are possible with the present invention, since the sensing paint or aqueous gel covers the entire exterior surface of a vehicle such as an aircraft. The corrosion sensing coating, therefore, can sense the cathodic reaction that accompanies the oxidative corrosion reaction described above by Equations (1) through (4). For localized corrosion such as pitting, crevice, and exfoliation corrosion, the cathodic reaction will tend to occur at more-accessible locations than the anodic reaction, i.e. nearer to the source of oxygen in the air, such as locations 40 which are proximate to the defects 35 as shown in FIG. 2.

The cathodic reaction causes an increase in the local pH at the location where it occurs, so a corrosion sensing paint or aqueous gel that is sensitive to pH increases generated by the cathodic reaction will indirectly be sensing corrosion occurring nearby. More specifically, the corrosion sensing composition of the present invention will visually change color to show localized cathodic corrosion and will also change color due to pH changes at a surface near, for example, a lap joint where hidden, remote anodic corrosion has occurred.

To demonstrate the paint or aqueous gel corrosion sensing capability of the present invention, a pH sensing coating was formulated from a clear acrylic paint matrix, for example, type ECS-8 paint available from Tru-Test Manufacturing Company or Cary, Illinois. The ECS-8 paint was mixed with different color-change (phenolphthalein or bromothymol blue) or fluorescing (7-hydroxycoumarin or coumarin) pH indicators so that the color change could be easily observed through the transparent acrylic matrix. These indicators were chosen as additives because the pH ranges over which they change color are in the alkaline region, for example, between approximately 8.2 to approximately 10 for phenolphthalein and between approximately 6 to approximately 7.6 for bromothymol blue. The indicators were added to the clear acrylic paint matrix at concentrations from between about 0.1 to about 2.4 percent by weight, which is the saturation concentration for phenolphthalein in acrylic. As will be known to those with skill in the art, both 7-hydroxycoumarin and coumarin are fluorescent acid-base indicators with pH ranges for fluorescing of between about 6.5 to about 8.0 and between about 9.5 to about 10.5, respectively. See, for example, FIG. 1 and the Encyclopedia of Analytical Science, A. Townshend, Editor, Academic Press, London (1995).

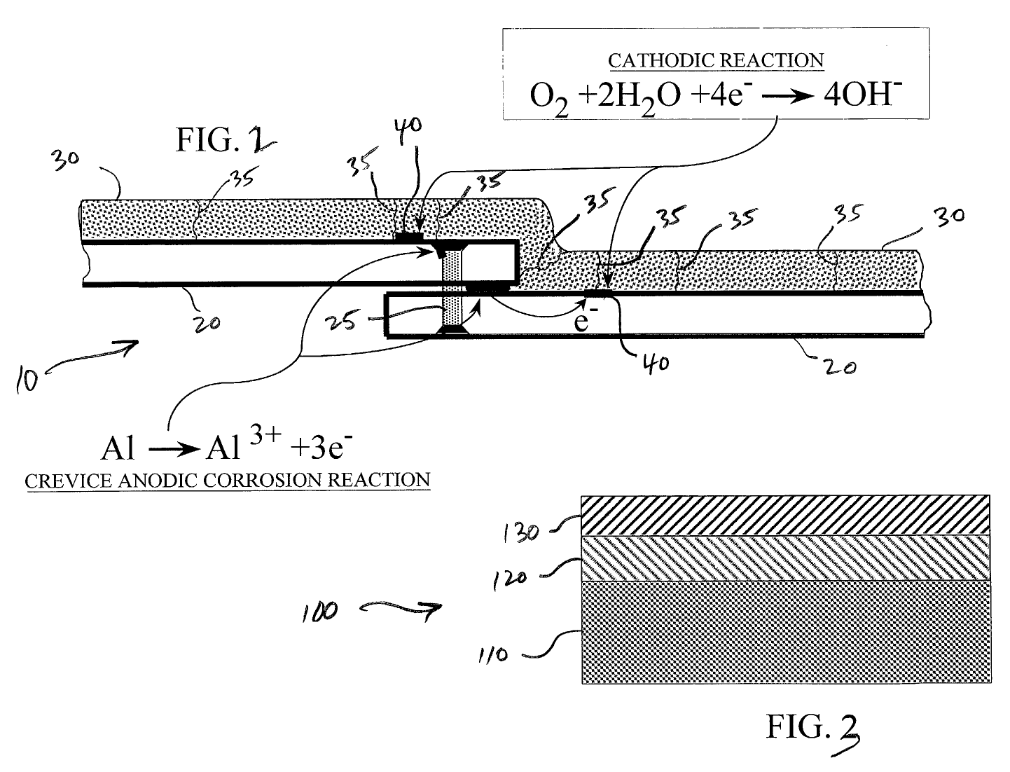

Several different methodologies were employed to establish the usefulness of using paints and aqueous gels as color-changing, corrosion sensing compositions. With reference next to FIGS. 2 and 3, mockups 100 were employed for testing each formulation of the paint or aqueous gel on aluminum samples 110. pH-corrosion sensing color indicating layers 120 of the clear acrylic matrix, having an added pH-corrosion sensing, color changing composition, were coated using a cotton swab on the surface of aluminum alloy samples 110 that were previously mounted in an epoxy and polished smooth with a 600 grit, water-based abrasive, such as #600 grit emery paper used with water. The thickness of the corrosion sensing coatings 120 was controlled by the adjusting the number of swab applications. The samples were then top-coated with a uniformly-sprayed clear acrylic layer 130 that contained no indicating compounds. The combined thickness of the two layers 120, 130 was between about 10 to about 20 micrometers (“μm”). Any change in color was monitored with the unaided eye of an observer having skill in the art. An ultraviolet (“UV”) lamp available from UVP Incorporated, that projected incident UV radiation with a major peak wavelength of about 365 nanometers (“nm”) was used for the pH-corrosion sensing systems containing fluorescent color-changing compounds.

The critical pH value for color change or fluorescence of each of the corrosion sensing compositions 120 was determined by titration by applying the various coatings to glass slides (not shown). The slide-mounted samples were immersed in stirred distilled water and drops of about 0.01, 0.1, or 1.0 molar (“M”) NaOH solution were added. The pH was recorded and the sample surface was monitored for color change or fluorescence. The effect of curing time on the color change or fluorescence response was determined for several modified acrylic-based coating systems. The time for initial color change or fluorescence was measured for coatings on glass slides in two or three selected pH solutions after various curing times.

Galvanic corrosion tests were also conducted to establish the efficacy of color-changing, corrosion detecting compositions in paints and aqueous gels. For these tests, a 4 millimeter (“mm”) diameter copper rod was inserted into a 5.5 mm diameter hole in an Aluminum 2024 alloy sample. The copper rod was electrically isolated from the aluminum sample by injecting epoxy in between the metals. The sample was mounted and polished to reveal a section of the copper rod concentrically placed within the aluminum 2024 alloy. The various pH sensitive coatings were applied on the polished surface. The sample was immersed in 1 M sodium chloride (“NaCl”) solution and the galvanic current was measured using a zero-resistance ammeter such as that available from Gamry Instruments and termed the PC3 with CMS 100 measurement software.

Electrochemical Impedance Spectroscopy (EIS) has been used widely to evaluate the resistance of coated metals to corrosion. See, for example, P. Carbonini, T. Monetta, L. Nicodemo, P. Mastronardi, B. Scatteia and F. Bellucci, Mat. Sci. For., 192-194, 291 (1995); J. V. Standish and H. Leidheiser, Jr., Corrosion, 36, 390 (1980); and M. Kendig and J. Scully, Corrosion, 46, 22 (1990). In continued efforts to establish the utility of color-changing, corrosion sensing compositions according to the present invention, EIS was performed on different types of acrylic-phenolphthalein indicating coatings using the Gamry Instruments EIS 900 system. An acrylic-based paint was formulated to have a color-changing, corrosion sensing indicator of about 0.5 or about 2.4 percent by weight (“% wt.”), and one or two indicating coating layers were applied to the sample, corresponding to a total coating thickness of about 15 μm and 30 μm, respectively. For the 2.4% wt. phenolphthalein content acrylic indicating coating, additional tests were performed on samples with an extra topcoat layer of pure acrylic having a thickness about 10 μm. Two or three samples were fabricated and tested for each type of color-changing, corrosion sensing composition. Also, as control experiments, samples coated with pure acrylic were tested by EIS at different immersion times. EIS tests were performed at prolonged immersion times in 1M NaCl, including the time for initial color change of the corrosion sensing coating. The EIS experimental parameters were as follows: frequency range 0.01 to 10,000 cycles per second (“Hz”), 10 points per decade, and ±10 millivolts (“mV”) potential amplitude relative to the open circuit potential. Immersion cells were covered completely to minimize evaporation during the immersion period. The initial color change time was monitored by visual inspection.

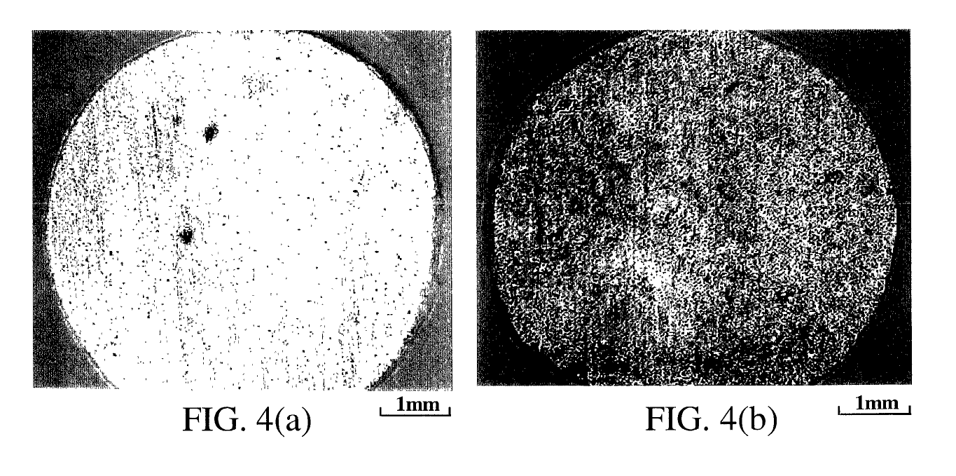

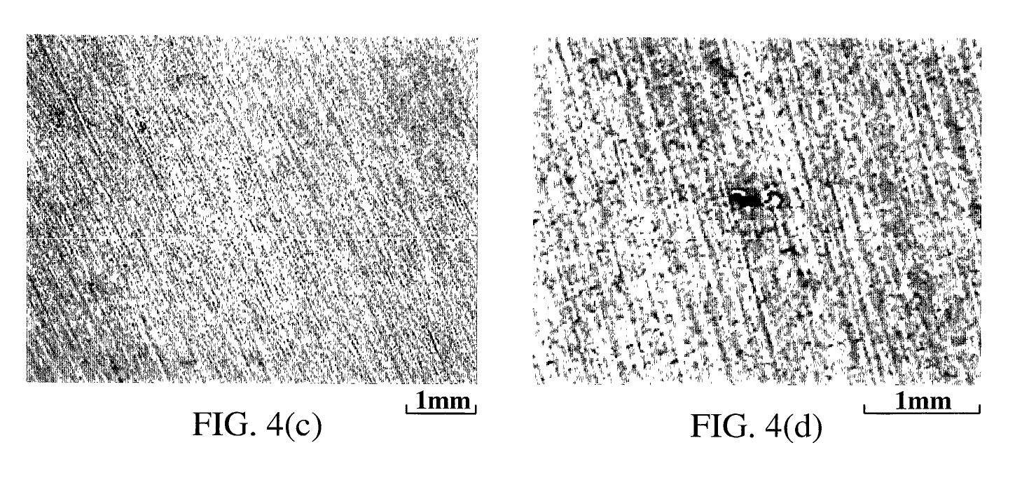

In additional experiments, two samples of an aluminum 5454 alloy were coated with different coating compositions and immersed in a 1 M NaCl bath for different immersion times and colored spots were seen to appear as shown in FIGS. 4(a) and 4(b). The spots were red and blue for acrylic-based coatings containing phenolphthalein and bromothymol blue, respectively. The appearance of the colored spots reflected that the spots of color change were, in fact, the sites of increased pH associated with the cathodic reaction of the local attack of the coated aluminum alloy in the chloride solution. As will be shown below, a volume of corroded material equivalent to a 15 μm radius pit will generate sufficient charge to create a color-change spot. Furthermore, the surface of a sample abraded and polished smooth in water with a #600 grit emery paper is relatively rough, compared to surfaces polished with even finer grit materials. Therefore, it is not possible to visually find the corroded area responsible for a small but visible color-change spot by microscopic examination.

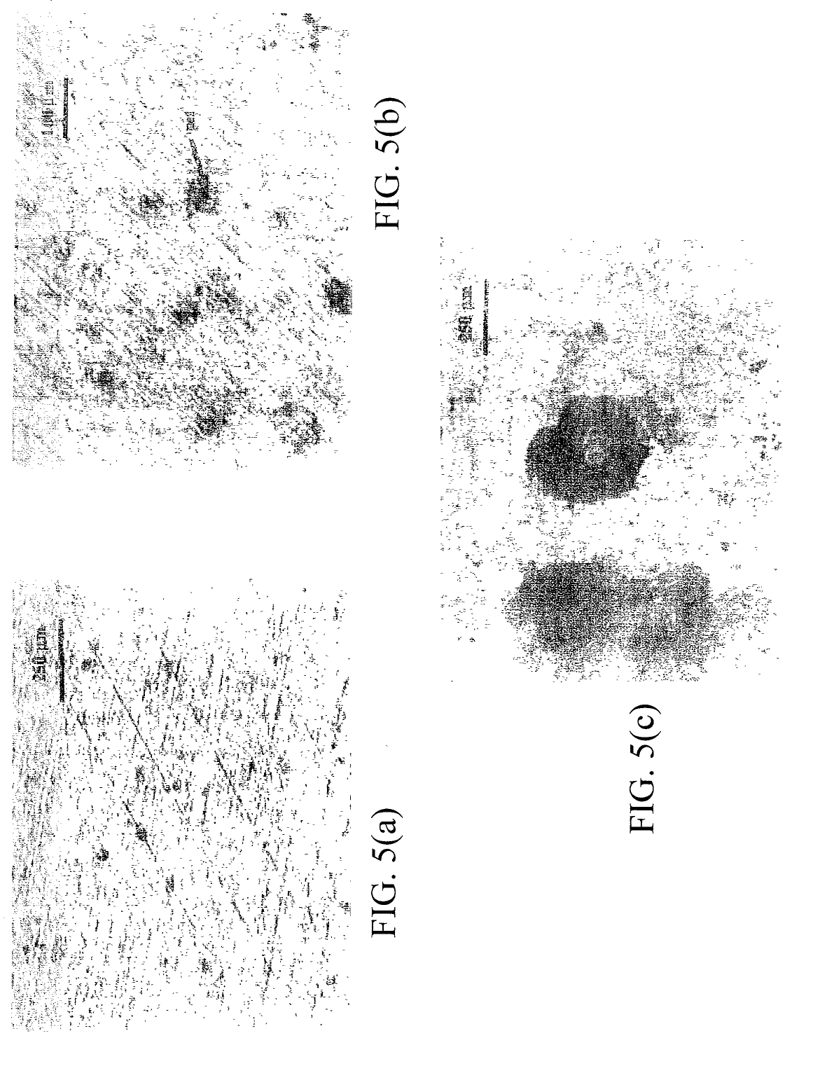

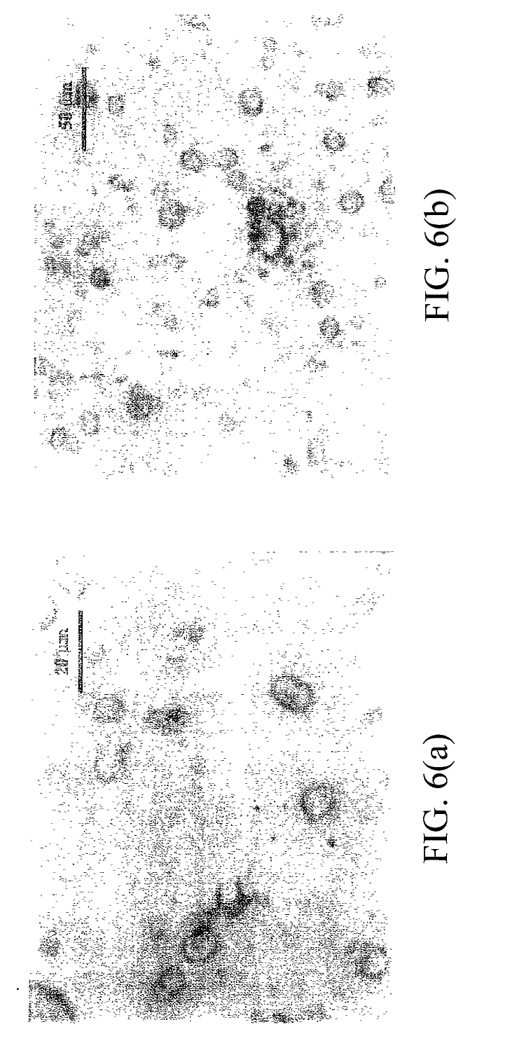

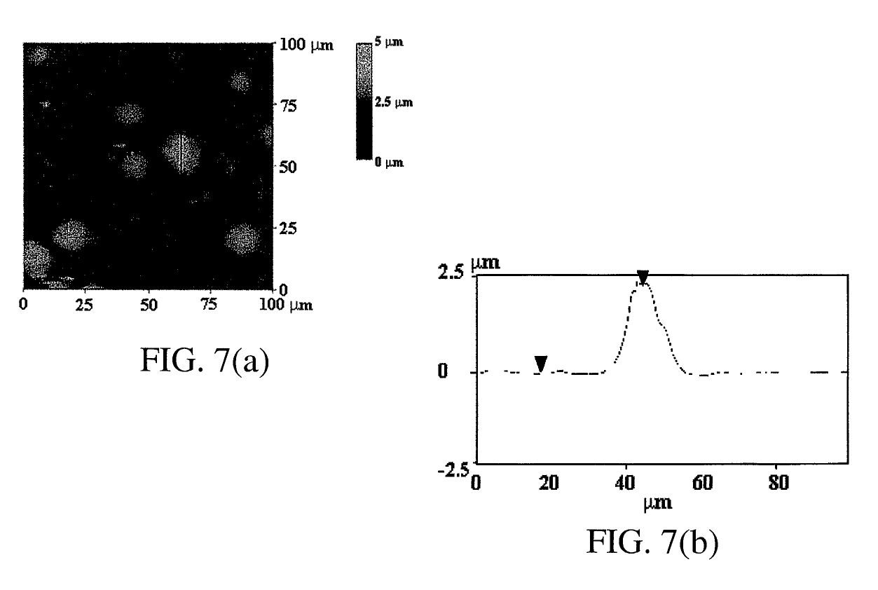

However, as shown in FIGS. 4(a) and 5(a), the initial color change spots do tend to be associated with polishing scratches, which may be sites for the initiation of localized attack. After extended immersion times, pits are clearly seen to develop near red-colored regions, FIGS. 5(b) and 5(c). In order to further demonstrate that the initial color change of the sensing coating is associated with corrosion processes, the same coating was applied to a sample polished extremely smooth using a 3 μm diamond paste and the sample was immersed in 1 M NaCl solution. The sample surface was observed by optical microscopy at magnifications of up to 1000 times at intervals of 5 minutes. With reference to FIGS. 6(a) and 6(b), it can be seen that red color change spots could be observed after only 20 minutes of immersion time, and pits were clearly associated with these red spots. The roundish features on the surface in FIGS. 6(a) and 6(b) were also present before solution exposure. These roundish features were examined by atomic force microscopy, which indicated that they were about 101 μm to about 20 μm in diameter and protruded from the surface by about 1 μm to about 3 μm, as can be understood with reference to FIGS. 7(a) and 7(b). These types of features are not found on the sample surfaces that were polished using a #600 grit emery paper prior to coating. It is assumed that they form as a result of lower surface tension at the interface of the acrylic and the highly polished sample surface.

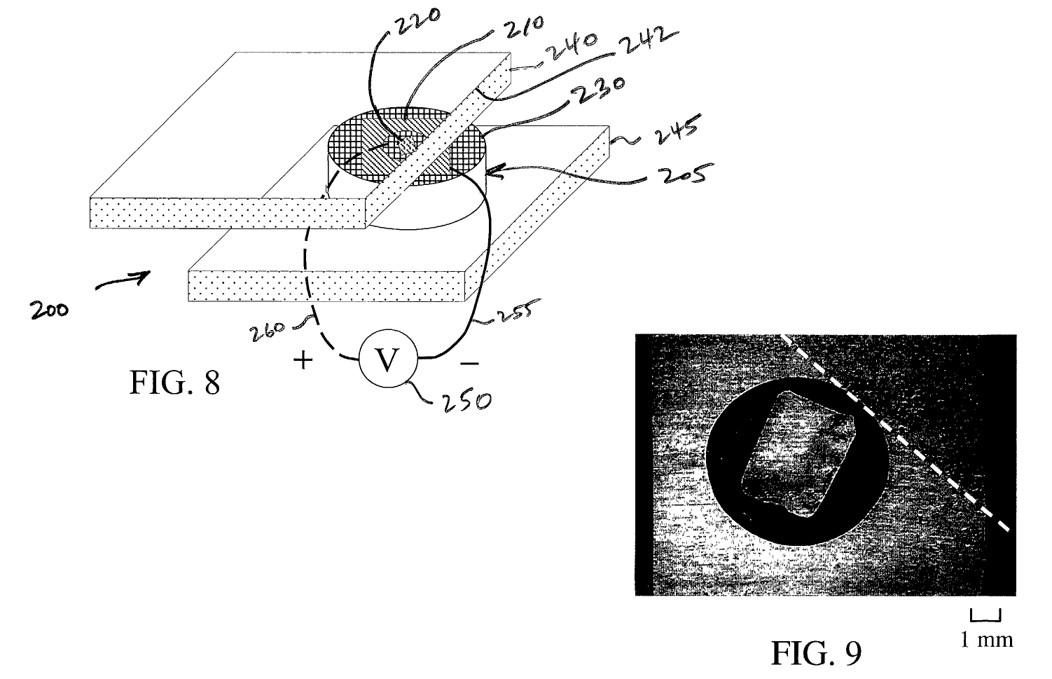

In order to check the assumption that a remote cathodic reaction associated with crevice corrosion could be detected, an artificial crevice cell assembly 200 was assembled as shown in FIG. 8. A test sample 205 was constructed using two pieces of aluminum 2024 alloy 210, 220 that were mounted in an epoxy substrate 230. The second piece 220 was to act as the inner electrode and is concentric to and electrically isolated from the first piece 210, which is to act as an outer electrode. After polishing and coating with an acrylic corrosion sensing composition having phenolphthalein in the amount of about 2.4% wt., the sample 205 was clamped between two sheets of clear-plastic material 240, 245, such as plexiglas, whereby the entire inner electrode 220 was completely covered and part of the outer electrode 210 was covered whereby the covering could prevent contact with a corrosive environment. The entire crevice cell assembly 200 was immersed in a 1 M NaCl bath, which served as a corrosive environment. To accelerate the electrical environment normally encountered in aircraft structures that lead to naturally occurring corrosion, a source potential 250 of 500 mV was applied via wires 255, 260 between the two electrodes 210, 220 wherein the current flowing to the inner electrode 220 was selected to have a positive bias relative to the other electrode 210. The simulated crevice corrosion test assembly 200 could thereby be tested as if it was a typical aircraft lap joint having a portion of the joint materials that are directly exposed to a corrosive environment and a portion that are indirectly exposed. As can be understood by those with skill in the art, the simulated crevice cell assembly 200 included a completely covered local anodic site at the inner electrode 220 that was surrounded by a partially covered cathodic area at the outer electrode 210.

The crevice cell assembly 200 was then immersed in the NaCl bath. As can be observed with reference to FIG. 9, after 26 hours a clear uniform red color developed on the portion of the outer cathodic electrode 210 that was not covered by the clear plastic material. The dark, angled, dotted line of FIG. 9 corresponds with the edge 242 of the transparent plastic material 240. The ohmic potential drop associated with current flow to buried regions of the outer electrode 210 resulted in most of the current flowing to the uncovered part of that electrode 210. After this extended immersion time, several pits formed on the outer part of the uncovered outer electrode 210 despite the applied cathodic current. These pits may have been regions of cathodic corrosion, to which aluminum alloys are susceptible. See, for example, G. S. Frankel, in Corrosion Mechanisms in Theory and Practice, P. Marcus and J. Oudar, Eds., Marcel Dekkar Inc., New York (1995). Nonetheless, the fact that the cathodic current flowed to the exposed cathodic area of the outer electrode 210 validates the approach of using a sensing coating system to detect the cathodic reaction associated with buried, inaccessible crevice corrosion occurring at the inner, anodic electrode 220.

As previously mentioned, the critical pH values for color change or fluorescence of various compounds are well known. See again, for example, FIG. 1 and Encyclopedia of Analytical Science, A. Townshend, Ed., Academic Press, London (1995). However, the values may change when these compounds are mixed with an organic matrix and applied to a surface. In order to determine the critical pH values of the coatings, titration tests were performed on samples consisting of glass slides coated with the sensing paint or aqueous gel, but no topcoat. These samples were immersed in deionized water, and sodium hydroxide (“NaOH”) was slowly added while monitoring the solution pH until a color change on the sample was observed. The results are given in Table 1.

TABLE 1
pH value for color change or fluorescence for pure compounds
(from Encyclopedia of Analytical Science,
A. Townshend, Ed., Academic Press, London (1995)) and
for compounds mixed into organic coatings.

| | pH indicators | | Fluorescing compounds | |
|---|---|---|---|---|
| | Pheno. | Bromo. | 7-hydroxy | Coumarin |
| pure | 8.2-10 | 6-7.6 | 6.5-8.0 | 9.5-10.5 |
| compound | | | | |
| clear acrylic | 10 | 10 | 7.0 | |
| 1200 primer | 9-12.5 | 9.5-11.0 | 7.4 | 13.1 |

It was found that the acrylic coatings, a first with a phenolphthalein content of about 2.4 % wt. and a second with a bromothymol-blue content of about 2.4% wt., had almost the same critical pH value for color change of about 10. Note that this pH value is well above the range of critical pH value for color change for pure bromothymol blue. See, FIG. 1. The critical pH value for the coating containing the fluorescing compound 7-hydroxycoumarin was much lower than that with other pH indicators. It is clear that the pH values for color change or fluorescence of these compounds are not necessarily the same after they are mixed with organic paint or aqueous gel matrices. In order to confirm the change in critical pH value after mixing pH indicators with acrylic, another commercial blue-tinted aluminum primer (#1200 from Tru-Test Mfg Co, Cary, Ill.), which contains acrylic resin, mineral spirits, glycol ethers, and ethyl acetate, was tested as a matrix containing pH indicators. Titration test results showed the same deviation from the critical pH values of pure compounds as described in Table 1.

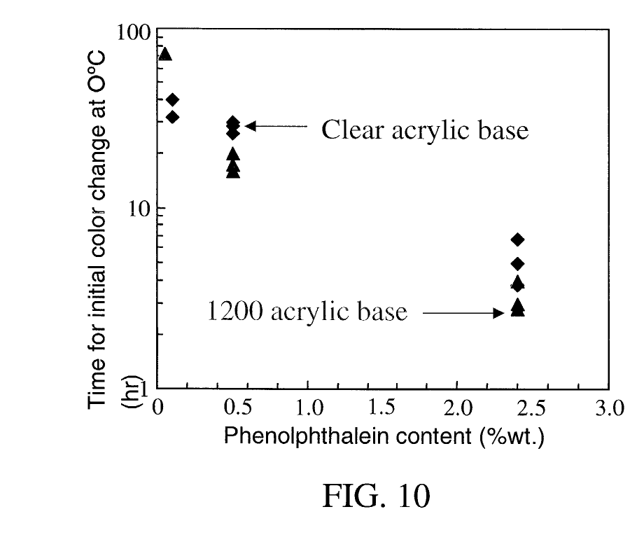

It is of interest to determine the sensitivity of the various coating systems to corrosion, i.e. how much corrosion is required before a color change is observed. One way to do this is to simply measure the time for the first sign of observable color change at open circuit in a certain solution. FIG. 10 shows the time for initial color change for phenolphthalein-containing coatings on aluminum 2024-T3 alloy immersed at open circuit in a 1 M NaCl bath. As the phenolphthalein content increases, a faster change in color is observed. This decrease in time for color change could be attributed to two separate factors: increased sensitivity of the coating to pH change, or decreased protectiveness of the coating leading to faster corrosion. It is therefore important to determine how much corrosion is needed for observable color change for each coating system independent of the coating protectiveness, and also to measure the protectiveness of each coating independent of its color change ability. As described below, a new sensitivity test was developed for the former, and EIS was used to test the latter property.

Since the color-changing, corrosion sensing composition or coating of the present invention senses corrosion by detecting the pH change associated with the cathodic reaction, one measure of the sensitivity of the coatings can be assessed by impressing a cathodic current on the metal and determining the time for color change. The sensitivity to pH change at the coating/metal interface is determined independent of the protectiveness of the coating because the cathodic current is forced. Constant cathodic current densities were applied to samples of the type shown schematically in FIG. 3 (i.e. not in the artificial crevice cell of FIG. 8) in a 1M NaCl solution. The samples were immersed in the solution for 10 minutes before each test. The time of the initial color change or fluorescence as determined by the unaided eye was measured for multiple values of applied current density.

Since current density, “i”, is defined as q/t, where q is charge density and t is time, the following relationship should exist between the elapsed time until detection of color change, t_{DET}, the charge density passed at detection, q_{DET}, and the applied current density, i_{APP}:

log t_{DET}=log q_{DET}−log i_{APP} (5)

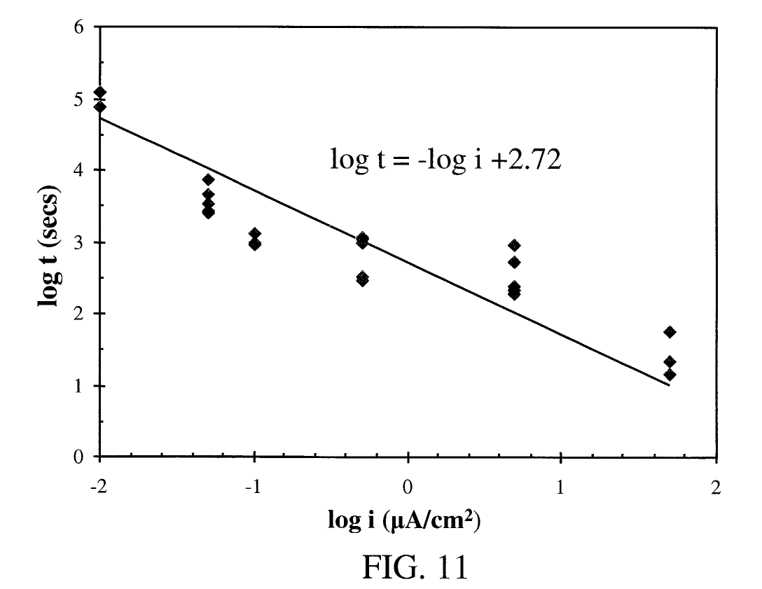

Therefore, a plot of log t_{DET} vs. log i_{APP} should have a slope of −1, and an intercept that provides a value of detectable charge density, which is a measure of the sensitivity. The data for the acrylic formulated with a phenolphthalein content of about 2.4% wt. indicator coating as well as a fit to Equation 5 are shown in FIG. 11. The detectable charge density is found to be 5.26×10⁻⁴ Coulombs per square centimeter (“C/cm²”). Assuming that this amount of charge was generated from a single hemispherical pit, the radius (or depth) of the pit, r, can be calculated from Faraday's law:

$$r ( cm ) = {( \frac{3}{2 π} \frac{{q}_{D E T} {A}_{C A TH}}{0.8} \frac{M}{ρ n F} )}^{1 / 3} = 2.74 \times {10}^{- 2} {( {q}_{D E T} {A}_{C A TH} )}^{1 / 3} = 2.2 \times {10}^{- 3} {A}_{CATH}^{1 / 3} \qquad ( 6 )$$

where A_{CATH} is the area over which the cathodic reaction is occurring in cm², M is the effective atomic weight of the alloy (close to about 27 g/mole for most aluminum alloys), ρ is the alloy density (close to about 2.7 g/cm³ for most aluminum alloys), n is the charge on the dissolved metallic ion (3 for aluminum), and F is Faraday's constant. It is also assumed in Equation 6that 20% of the anodic charge in the pit would be consumed locally by hydrogen evolution in the pit. See, G. S. Frankel, Corrosion Science, 30, 1203 (1990).

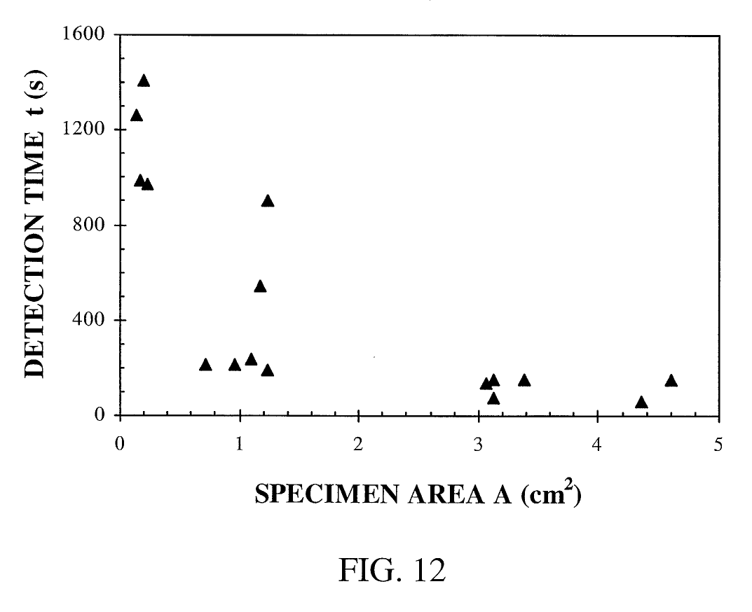

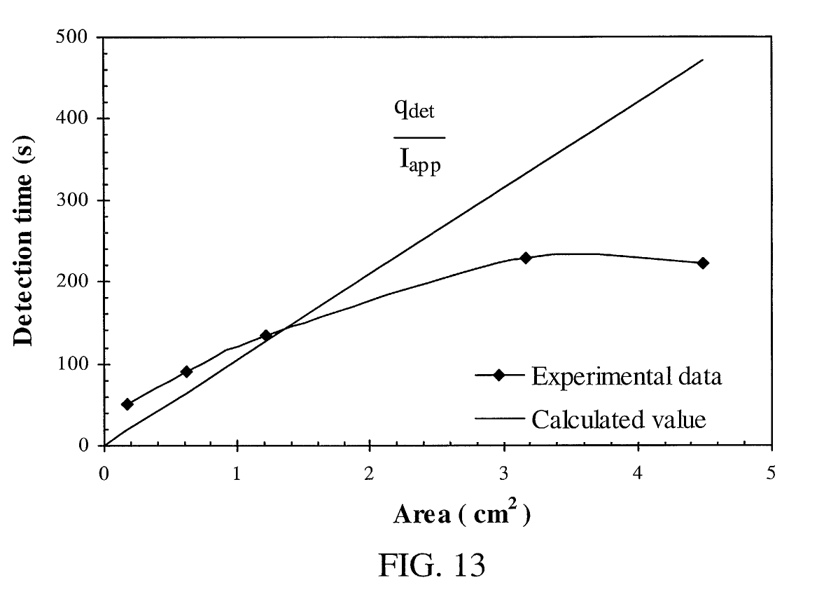

It is apparent from Equation 6 that the size of a detectable “effective” pit should be related to the size of the cathodic area. In other words, if the anodic charge associated a pit is spread over a larger cathodic area, more charge (more time, or a larger “effective” pit) would be required to cause a color change. However, there is a problem with this analysis. According to Equation 5, the detection time should be independent of sample area for a constant value of applied cathodic current density. FIG. 12 shows the effect of sample area on the sensitivity measurement for the acrylic coating having a phenolphthalein content of about 2.4% wt. corrosion sensing composition with an applied cathodic current density of 5 microamperes per square centimeter (“μA/cm²”). It is clear that the detection time decreases with increasing sample area, in contrast to the expectations of the model. Another way to approach this discrepancy is to measure the detection time for different sample areas using a fixed applied current instead of a fixed current density. For a fixed current, I_{APP}, the time for detection in the sensitivity experiments should vary with the sample area according to Equation 7:

t_{DET}=(q_{DET}/I_{APP})A_{CATH} (7)

FIG. 13(a) shows the effect of sample area on the detection time with a constant applied cathodic current of 5 μA, as well as the relationship expected from Equation 7 using the previously-determined value of q_{DET}. The experimental data matched the expected values well when the area was less than 1.2 cm². For larger sample areas, however, the measured detection times were smaller than the expected values.

Another interesting observation was that the initial color change that occurred in these experiments happened at small spots rather than uniformly over the whole area, as shown in FIGS. 4(c) and 4(d). These spots of color change appeared at essentially the same time. This localized effect also occurred during corrosion at open circuit, as shown in FIGS. 4(a) and 4(b). The applied current will not flow uniformly to the electrode surface, but will instead tend to flow to the defective areas in the coating. This is also the case in a real coated crevice. Since a larger sample area will statistically be more likely to have severe defects, the time for detection will actually decrease rather than increase with increasing sample area. These observations must be taken into account for improvement of the selection and testing process for useful corrosion sensing compositions according to the present invention.

Assuming, that the current flowing to a given coated sample is distributed among N defective points, the charge passed at the point of detection is then a total charge, Q_{TOT}, which is equal to (N×Q_{DET}), where Q_{DET} is the critical charge required for detection of each single spot. The previous discussion can thus be modified according to Equations 8 and 9:

I_{APP}=Q_{TOT}/t_{DET}=(Q_{DET}N)/t_{DET} (8)

log(t_{DET}/N)=log Q_{DET}−log I_{APP} (9)

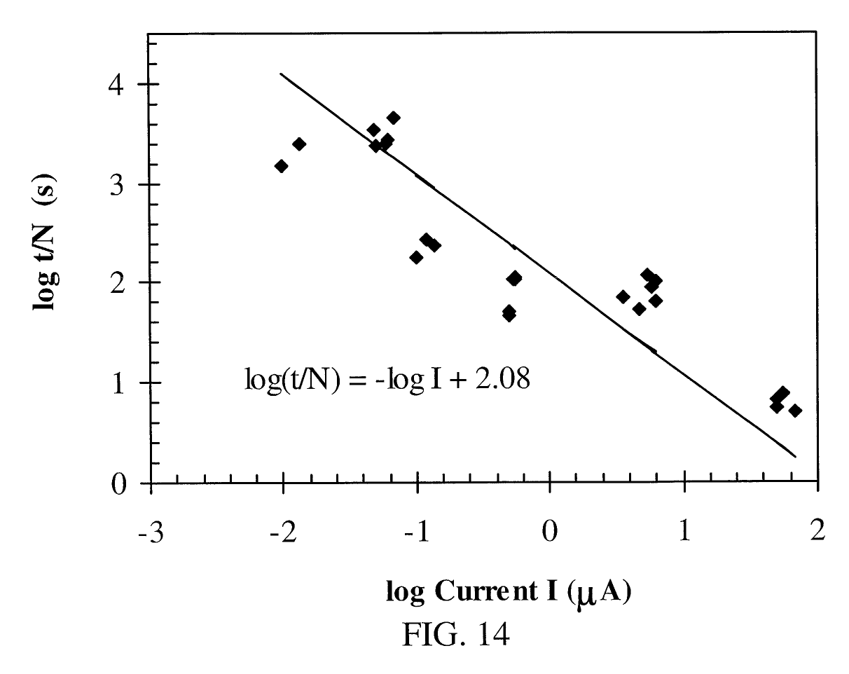

According to the equations, a plot of log (t_{DET}/N) vs. log I_{APP} should have a slope of −1, and an intercept that provides a value of detectable charge. FIG. 14 shows the data replotted in this fashion, along with a fitted line with slope −1. N was taken to be the number of the first color change spots to appear. From the intercept in FIG. 14, Q_{DET} can be determined to be 1.22×10⁻⁴ coulombs (“C”). The form of Faraday's law shown in Equation 9 needs to be altered to consider the detection charge instead of charge density:

$$r ( cm ) = {( \frac{3}{2 π} \frac{{Q}_{D E T}}{0.8} \frac{M}{ρ n F} )}^{1 / 3} = 2.74 \times {10}^{- 2} {( {Q}_{D E T} )}^{1 / 3} \qquad ( 10 )$$

This “effective” pit size is independent of the cathodic area, but dependent on the number of defects, N, since the intercept in plots like FIG. 14 will be dependent on N. Using the value for Q_{DET} of 1.22×10⁻⁴ C, the size of an effective detectable pit with the acrylic/phenolphthalein system was then 13.6 μm. The detectable pit depth determined in this fashion was used in this study as a measure of the sensitivity of the indicating coating systems. A small detectable pit depth is thus associated with a highly sensitive coating. This approach to determination of the sensitivity of these coating systems of the present invention to underlying corrosion suggests that a very small amount of corrosion can be detected.

Following the method discussed above, the sensitivities of different sensor coating systems were determined as described in Table 2.

TABLE 2
Comparison of corrosion sensing behavior
of various, modified organic paints

| Organic Matrix: | Acrylic | | Acrylic | Acrylic | |
|---|---|---|---|---|---|
| Indicator | Phenolphthalein | | Bromo. | 7-hydroxy. | |
| Topcoat (acrylic) | With | w/o | With | w/o | w/o |
| Content (% wt.) | 2.4 | 2.4 (two layers) | 2.4 | 0.1 | 0.5 |
| Time for initial color | 5.2 | 0.94 | 5.5 | 0.78 | 0.31 |
| change (hours) | | | | | |
| Effective Pit Radius | 13.6 | 7.9 | 12.7 | 4.9 | 2.02 |
| (μm) | | | | | |

It should be noted that different ranges of applied constant cathodic current were used for the different coating systems due to the differences in color change or fluorescence response. The results in Table 2 are well-correlated with the critical pH values determined for the different systems as can be understood with reference to Table 1. The sensitivity of the acrylic-based systems with phenolphthalein and bromothymol blue were similar (and probably within the error of the analysis), which corresponds to the fact that the critical pH determined from titration for these two systems was identical. The acrylic-based coating with 7-hydroxycoumarin was much more sensitive as it exhibited a very small detectable pit size. Furthermore, the sensitivity increased (detectable pit radius decreased) as the 7-hydroxycoumarin content increased to 0.5 % wt. Furthermore, the response of this system was extremely long-lived compared to other systems. The fluorescent spots could easily be seen for long periods of time (several hours to several days, depending upon the charging conditions) after the cessation of the cathodic current and removal from solution. In contrast, the systems with phenolphthalein reverted back to colorless after less than 1 hour following the cathodic treatment and removal from solution. This fading took somewhat longer, about 12 hours, following long term immersion in chloride solution at open circuit. It is therefore clear that the critical pH values of the organic matrix/pH color-changing-indicator mixtures have a strong effect in determining the sensitivity of the coating system for corrosion detection.

During experiments where 2024-T3 was galvanically coupled to a piece of copper and covered with an acrylic coating having a phenolphthalein content of about 2.4% wt., color change only occurred on the surface of copper sample where the cathodic reaction predominated. The critical charge at the time of initial color change can be calculated from integration of the measured current by the zero resistance ammeter. This charge can be converted to an effective pit size in order to determine the sensitivity of the coating. For the acrylic-phenolphthalein (2.4 % wt., two layer) coating, the effective observable pit size determined from the galvanic corrosion experiment was found to be about 7.5 μm, which corresponds well to the results from the constant cathodic current sensitivity tests of about 7.9 μm. This suggests that the galvanostatic approach for sensitivity used in this study for accelerated testing is reasonable.

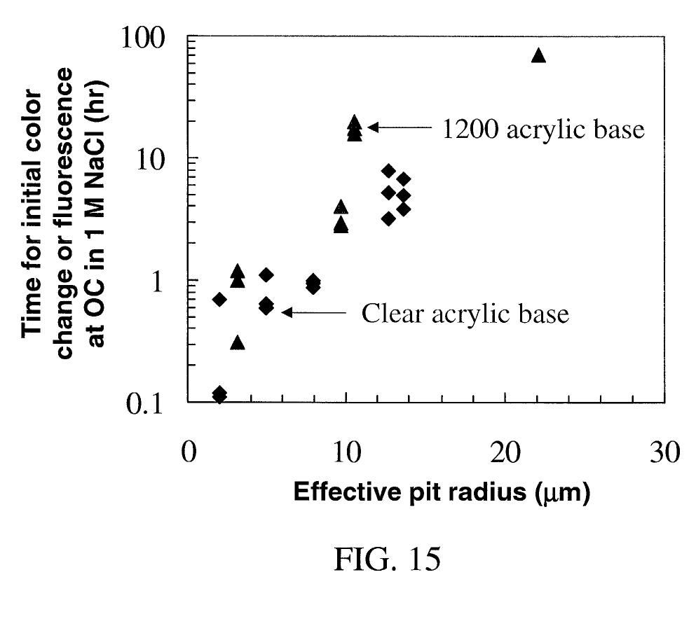

A comparison of the time for initial color change at open circuit to the effective detectable pit radius determined by the galvanostatic sensitivity test is given in FIG. 15 for a range of coating systems. It is clear that there is a correlation between the two values of sensitivity, which were measured in totally different fashions. The time for initial color change at open circuit is influenced by both the protectiveness of the coating and the sensitivity of the color-changing composition to an increase in pH. The galvanostatic test, however, imposes a current, and is thus independent of the coating protectiveness. The correlation of the two values suggests that the time for initial color change is not determined by coating protectiveness, but rather by the sensitivity to pH change.

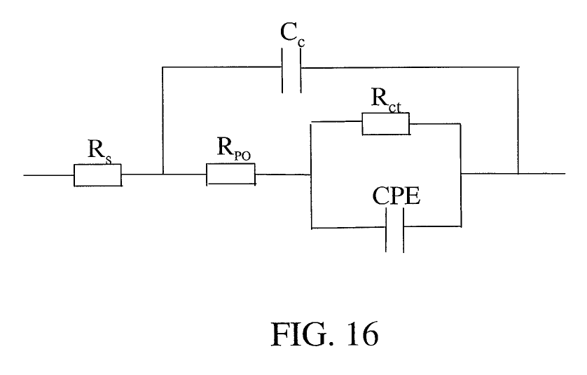

The protectiveness of the coatings was also determined independent of their sensitivity to pH using EIS experiments. The EIS data were obtained using the Gamry Instruments EIS 900 system Z-View program and then the data were fitted to the equivalent electrical circuit shown in FIG. 16. As referenced in FIG. 16 and the following discussion, R_{PO} represents the pore resistance, R_{CT} represents the charge transfer resistance, Rₛ represents the electrolyte resistance, C_{C} represents the coating capacitance, and CPE represents a constant phase element.

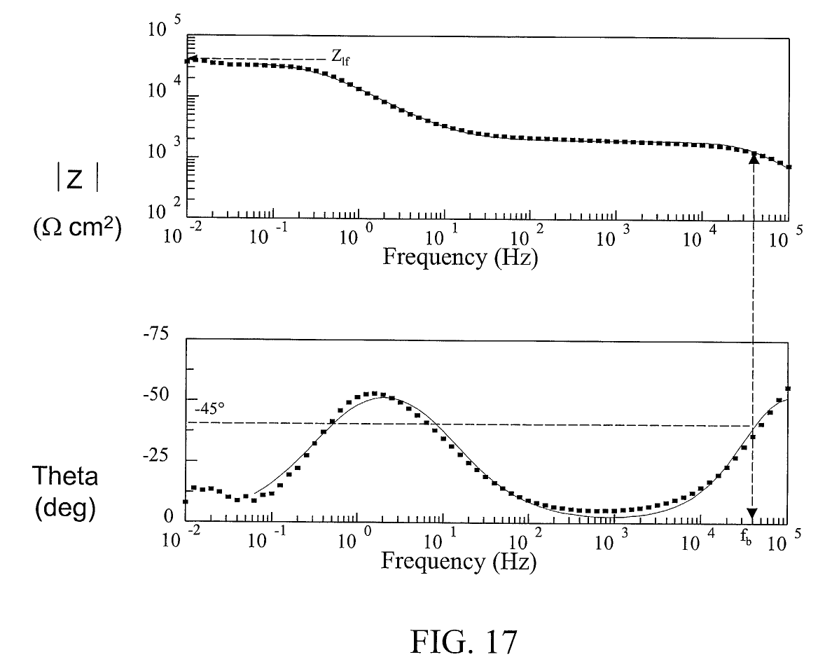

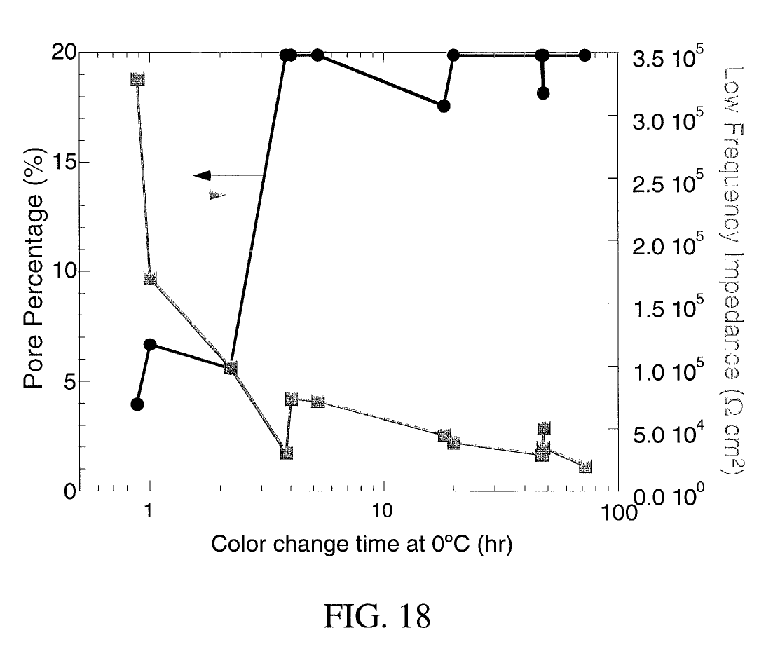

Breakpoint frequency values, f_{b}, were also determined from the EIS data and were used to calculate values of pore percentage according to methods described in the literature. See, S. Haruyama, M. Asari, and T. Tsuru, in Proc. Symposium on Corrosion Protection by Organic Coatings. M. Kendig and H. Leidheiser Jr., editors, The Electrochemical Society, Pennington, N.J. (1987); and F. Mansfeld and C. H. Tsai, Corrosion, 47, 958 (1991). An example of a fit obtained in this fashion is shown in FIG. 17. For acrylic-based corrosion sensing coatings, such as acrylic paints and aqueous gels, used on aluminum 2024 alloy, it was found, as expected, that the coating and double layer resistance decreased, and the coating and double layer capacitance increased, with increasing immersion time in 1M NaCl. Values of S/S⁰, the pore percentage, low-frequency modulus, are given in FIG. 18 as a function of color change time at open circuit for a variety of coating systems.

The data plotted in FIG. 18 reveal that for coating systems with times for initial color change of less than 4 hours, which are the most sensitive coating systems, the pore percentage, S/S⁰, decreases and low-frequency impedance, Z_{lf}, increases as the open circuit color change time decreases. The pore resistance and charge transfer resistance of the coatings also vary with color change time in this range. The pore percentage and various equivalent circuit parameters do not change further for coating systems having color change time longer than about 4 hours. The pore percentage calculation is limited at 20% because of the limited frequency range of the measurement equipment. The relationship of time for color change at open circuit and corrosion sensitivity from the galvanostatic approach, as represented by the data of FIG. 10, indicates that short times for color change were not a result of low coating protectiveness. The relationship of the data of FIG. 15 further supports for this finding. The coatings with the shortest color change time actually had the highest low-frequency impedance and the lowest pore percentage. The relationships of Rₚₒ, R_{ct}, S/S⁰, effective detectable pit radius, and time for initial color change verify the breakpoint frequency theory discussed by S. Haruyama, M. Asari, and T. Tsuru, in Proc. Symposium on Corrosion Protection by Organic Coatings. M. Kendig and H. Leidheiser Jr., editors, The Electrochemical Society, Pennington, N.J. (1987); and F. Mansfeld and C. H. Tsai, Corrosion, 47, 958 (1991). It is possible that the decreased time for color change associated with the most-protective coatings is a result of effective trapping of the solution in the pores compared to the less protective coatings.

From the preceding discussion, one having ordinary skill in the art would make the following conclusions. Color change or fluorescence associated with the pH increase caused by the cathodic reaction in the corrosion process was easily seen with the unaided eye. The critical pH for color change or fluorescence changed when an indicating compound was mixed with an organic matrix. The time for observable initial color change at open circuit decreased as the concentration of pH indicator in the coating system increased. The sensitivity of these coating systems was determined by passing constant cathodic current and determining the charge at which color change or fluorescence was detected. This was related to the radius of an effective pit. Pit sizes on the order of 10 μm were found to be detectable by the unaided eye with the coating systems studied. The time for observable initial color change at open circuit was proportional to the effective detectable pit radius determined from the constant current experiments. Coatings with short times for observable initial color change at open circuit exhibited high low-frequency impedance and low pore percentage, as calculated from the breakpoint frequency. The time of initial color change at open circuit was determined to be dependent on the pH sensitivity of the coating, and not the coating protectiveness.

We next turn the focus to a detailed description of the variations of the corrosion sensing, color changing, gel coating variation of the present invention. As previously described, a corrosion sensing coating may also employ a temporary coating that is applied for a short period of time in order to detect corrosion. The temporary coating is designed to indicate where on a given structure corrosion is occurring. Once corrosion has been identified, the coating is removed so that corrosion correction and repair measures can be implemented. In certain situations, the previously discussed polymer coating is stripped off during a regular maintenance and inspection of an airplane, which could provide access to the underlying metal surfaces for application of a temporary, corrosion sensing, color changing coating. An agar-based gel coating is a good choice for a corrosion sensing medium due to its availability and solubility in water, which allows it to be easily removed. See, for example, R. Takano, K. Hayashi, and S. Hara, Phytochemistry, 40, 487-490 (1995).

Agar has been used as an indicator carrier in various applications including, for example,

(1) Biochemistry, see, Zesheng Liu, Myriam Reches, and Hanna Engelberg-Kulka, Analytical Biochemistry, 244, 40-44 (1997); V. E. Donohue, F. McDonald, and R. Evans, Journal of Applied Biomaterials, 6, 69-74 (1995); and M. Weiland, A. Daro, and C. David, Polymer Degradation And Stability, 48, 275-289 (1995);

(2) Medicine, see, M. J. Bale, C. Yang, and M. A. Pfaller, Diagnostic Microbiology And Infectious Disease, 28, 65-67 (1997); and

(3) Microelectronic sensors, see W. Ziegler, J. Gaburjakova, M. Gaburjakova, B. Sivak, V. Rehacek, V. Tvarozek, T. Hianik, Colloids And Surfaces A: Physicochemical And Engineering Aspects, 140, 357-367 (1998); and D. P. Nikolelis, V. G. Andreou, C. G. Siontorou, I. Novotny, V. Rehacek, V. Tvarozek, W. Ziegler, Materials Science And Engineering: C, 5, 55-58 (1997); and

(4) Corrosion, see, J. Colreavy and J. D. Scantlebury, Journal of Materials Processing Technology, 55, 206-212 (1995). Others have developed a thin electrode system with an agar gel electrolyte as a support medium for the construction of bilayer lipid membranes that are stable to mechanical and electrical shock. See, D. P. Nikolelis, et al. Also, a chromogen agar paper (CAP) impregnated by an enzyme substrate and electron acceptor has been applied to diagnose diseases by identifying the color change induced by reaction during incubation. See, D. A. Christensen and P. Nash, Biotechnology Advances, 15, 429 (1997). In a motion picture entitled Corrosion in Action, produced by The International Nickel Company, Inc., New York, N.Y., (1977), agar was used as a vehicle for corrosion monitoring in several different experiments. An iron nail partially plated with copper was immersed in an agar-gel having 1.2% wt. agar, 3% wt. NaCl, 1% wt. phenolphthalein, and 5% K₃Fe(CN)₆. That experiment identified the locations of the anodic and cathodic processes. The area around the dissolving iron was enriched in Fe²⁺ and reacted with K₃Fe(CN)₆ in which Fe is in the Fe³⁺ state, which resulted in the gel exhibiting a blue color. Near the copper plating of the nail, the phenolphthalein turned red because of high concentrations of OH from the cathodic reduction reaction. An agar-gel has also been used as a medium to detect the corrosion processes in a butt-welded panel, and to characterize the effect of surface pre-treatment on the corrosion regions by identifying the anodic and cathodic regions. See, J. Colreavy and J. D. Scantlebury, Journal of Materials Processing Technology, 55, 206-212 (1995).

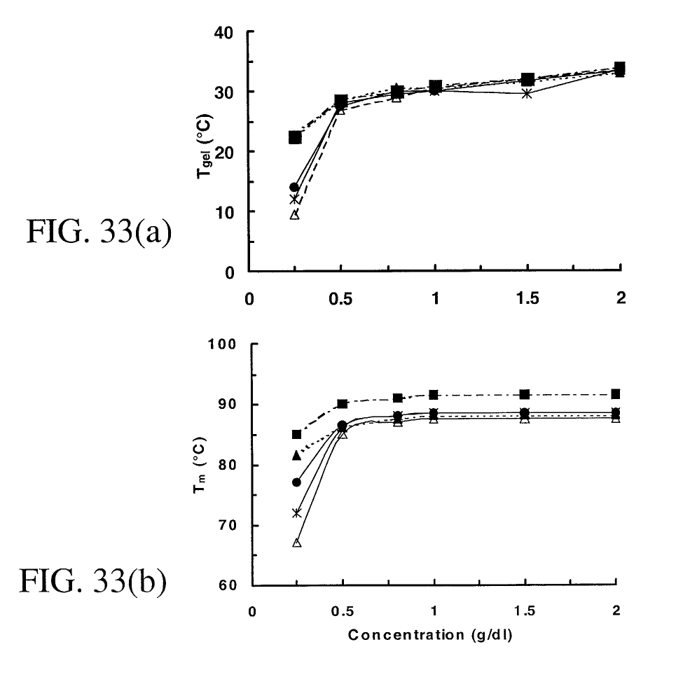

The specific carrier capacities of agar-gel can be attributed to its chemical structure and physical properties. Agar is composed of gel-forming polysaccharides isolated from red sea-weed, a type of marine algae of the division Rhodophyta, and has a linear polymer structure based on a disaccharide repeat unit that consists of alternating 3-linked β-D-galactopyranosyl and 4-linked 3,6-anhydro-α-L-galactopyranosyl units substituted with high levels of methyl ether groups. See, for example, R. Takano, et al. The relationship between gelling properties and agar-gel structure has been studied in detail. See, for example, R. Takano, et al.; R. Falshaw, R. H. Furneaux, D. E. Stevenson, Carbohydrate Research, 308, 107-115 (1998); and M.-F. Lai and C.-y. Lii, International Journal of Biological Macromolecules, 21, 123-130 (1997). Falshaw et al. reported a comparative study of the isolation, chemical structure, and gelling properties of nine agar species. They found that methylation can significantly increase the gel-forming ability and the extent and position of methylation will affect the gelling/melting temperature of the agar gels, which correlated to the results from the previous study by Takano et al., Recently, Lai et al. researched the Theological and thermal characteristics of gel structures and showed that gelling (T_{gel}) and melting (Tₘ) temperatures, storage moduli (G′), and the enthalpy (ΔH) values of agar gels were mainly associated with the viscosity of agar-gel. Furthermore, they concluded that the Theological and thermal properties of agar-gel varied not only with the agar concentration, but also with the stage of the gelation process. See also, FIGS. 33(a) and 33(b), which are taken from Lai et al.

An approach for corrosion detection using agar-gel as a carrier has been demonstrated by the inventors. A modified agar-containing-solution was impregnated with a color-change pH indicator (or fluorescing compound) and NaCl at various concentrations. NaCl was applied with the consideration that the environment of the previously corroded area should be reproduced in order for the modified agar-gel to detect its location quickly. Corrosion sensing behavior was established by applying the modified agar-gel coating on aluminum alloy 2024-T3 after prolonged immersion time in 1M NaCl for corrosion initiation. The difference of pH sensing behavior associated with corrosion processes is discussed in relation to the gelation processes and the structure of modified agar-gels. Agar-gels were synthesized by the hydrolysis of polysaccharides with distilled water as described by Falshaw et al. The procedure for modified agar-gel formation included three steps. Initially, agar power was mixed with distilled water, NaCl and indicator chemicals (phenolphthalein or 7 hydroxycoumarin) in various amounts, as shown in Table 3 and the mixture was stirred using a magnetic stirrer for at least 1 hour.

TABLE 3
Corrosion sensing gel components and testing results.

| | | | | | | Color change behavior | |
|---|---|---|---|---|---|---|---|
| Gel component | | | | Corrosion sample condition | | Time after applying | |
| Agar | Pheno | 7-hydroxy- | NaCl | Immersion time | DI water | gel | |
| % wt | % wt. | coumarin | % wt. | in 1 M NaCl | washing | (Avg. of three) | Disappearance time |
| 0.49 | 0.24 | | 1.7 | 0 | | No change | |
| | | | | 5 min | N | 20 s | >10 hr |
| | | | | 5 min | Y | 48 s | >10 hr |
| | | | | 10 min | N | 10 s | >10 hr |
| | | | | 10 min | Y | 54 s | >10 hr |
| | | | | 30 min | N | 10 s | >10 hr |
| | | | | 30 min | Y | 63 s | >10 hr |
| 0.49 | 0.24 | | 0 | 0 | | No change | |
| | | | | 5 min | N | 38 s | 60 s |
| | | | | 5 min | Y | No change | |
| | | | | 10 min | N | 18 s | >10 hr |
| | | | | 10 min | Y | 8 mins | >10 hr |
| | | | | 30 min | N | 20 s | >10 hr |
| | | | | 30 min | Y | 10 mins | >10 hr |
| | | | | 132 min | Y | 38 s | >10 hr |
| 0.49 | 0.05 | | 1.7 | 0 | | No change | |
| | | | | 5 min | N | 172 s | >10 hr |
| | | | | 5 min | Y | 15 min | >10 hr |
| | | | | 10 min | N | 120 s | >10 hr |
| | | | | 10 min | Y | 132 s | >10 hr |
| | | | | 30 min | N | 60 s | >10 hr |
| | | | | 30 min | Y | 80 s | >10 hr |
| 0.49 | 0.05 | | 0 | 0 | | No change | |
| | | | | 5 min | N | 15 min | 50 min |
| | | | | 5 min | Y | No change | |
| | | | | 10 min | N | 420 s | >10 hr |
| | | | | 10 min | Y | 12 min | >10 hr |
| | | | | 30 min | N | 35 s | >10 hr |
| | | | | 30 min | Y | 200 s | >10 hr |
| 0.73 | 0.24 | | 1.7 | 0 | | No change | |
| | | | | 10 min | N | 10 s | >10 hr |
| | | | | 20 min | N | 33 s | >10 hr |
| 0.24 | | 0.01 | 1.7 | 0 min | N | 1 s | >10 hr |
| | | | | 5 min | Y | 1 s | >10 hr |

The suspension was then heated to 80-95° C. and kept at this temperature for about 10 to 20 minutes before cooling. The beakers containing the suspension were covered by a glass cover to prevent or slow water evaporation during the heating processes. Finally, heating was terminated and the solution was cooled to room temperature as stirring continued. The pH of the modified agar-gel solution was measured both before heating and following cooling.

The critical pH value of color change or fluorescing behavior for modified agar-gel (with pH indicators or fluorescing compound) before and after the gelling process was measured by a titration test. NaOH (0.01M) was added to the stirred agar solution and agar-gel while the pH was monitored. The critical pH value was determined when the initial color change or fluorescing behavior under an ultraviolet light source was observed on the gel surface. A suitable light source is available from MVP Inc. that incorporates a major beam wavelength of about 365 nm.

The modified agar gel was analyzed to ascertain the precise quantities of constituents using a Scintag Pad-V X-ray diffractometer (“XRD”). That is accomplished using the XRD because crystalline structures, such as those associated with the embodiments of the present invention, will diffract x-rays in a manner that corresponds to the periodic structure in the atomic lattice of the crystalline structure. However, an amorphous structure will not show any diffraction peaks because the atoms are not in periodic positions. The diffracted x-rays are collected and observed as a function of incident angle. Each atomic structure will generate a series of peaks with varying intensity at specific angles, which were determined previously for known substances by experimentation. The relative intensities and the peak positions are essentially “fingerprints” of the material and its structure. Therefore, x-ray diffraction can be used to identify a crystalline structure—both the structure and the material. Various types of software and “known-substance” databases are available for comparison of experimental data with a library of known materials and structures. With these considerations in mind, the samples A1, B, and C listed in Table 4 were tested by XRD. Sample A2 was tested differently as described below. Table 4 describes sample conditions for XRD and environmental scanning electron microscopy (“ESEM”) analysis. The angle was scanned at 1 degree/min over a range of about 25-60 degrees. The agar gel was spread on a plastic sample holder that was then placed onto the diffractometer. The software program Eva was used for analysis of the diffraction data by comparison with standard peak 2-theta values for pure chemicals such as phenolphthalein and NaCl. The diffraction data were analyzed by comparison with standard peak 2-theta values for pure chemicals such as phenolphthalein and NaCl.

TABLE 4
Sample Condition for XRD and ESEM Analysis.

| Sample | Components | | | |
|---|---|---|---|---|
| No. | Agar (g) | Pheno. (g) | NaCl (g) | H₂O (ml) |
| Sample A1 | 0.2 | 0.02 | 0.7 | 40 |
| Sample A2 | 0.2 | 0.1 | 0.7 | 40 |
| Sample B | 0.2 | 0 | 0 | 40 |
| Sample C | 0.2 | 0.1 | 0 | 40 |

During preparation, the aluminum alloy 2024-T3 samples listed in Table 4 were cut into approximately 0.6 cm×0.8 cm pieces and mounted in an epoxy substrate. The mounted sample surface was then polished smooth with 600 grit, water-based abrasive, such as #600 grit emery paper. Before testing, samples were stored in a desiccator for at least 24 hours to keep consistent surface conditions. Corrosion was initiated either by simple immersion in a 1 M NaCl solution or by applying an anodic current of 100 μA for 1-5 min. The samples were then taken out of solution, rinsed with deionized water and dried with hot air, or just dried with hot air without water-washing, depending on the experimental conditions as described in Table 3. Next, the gel coating was applied by dipping the pre-immersed samples into the gel suspension and slowly pulling them out. The time for initial color change was recorded from the moment of gel coating application. The properties of gel coatings were observed, such as the transparency of the coating, gel quality, and the coating aging behavior for different gel compositions.

Observation of the morphology of the gel coating after the gelation process, was accomplished with a Philips Environmental Scanning Electron Microscopy (XL30 FEG ESEM) that was employed in a low vacuum environment because the gel contains a small amount of water. The chamber pressure was controlled to approximately 4.9 torr of air. The agar-gel was not electrically connected to the sample holder because the surface charging due to low conductivity, as in the situation of SEM (scanning electron microscopy), is minimized in the ESEM. Samples A2, B, and C, as listed in Table 4 were examined by ESEM.

To understand the physical and chemical interaction between the agar-gel and pH indicator (phenolphthalein), the structure and morphology of the modified gels was analyzed using the XRD and ESEM observations above. Of the three gels listed in table 4 that were examined by XRD (samples A1, B, and C), only sample A1, which contained NaCl, exhibited strong diffraction peaks. The peaks were identified as being associated with NaCl by comparison with known data sets including that of NaCl. The absence of expected peaks associated with phenolphthalein is apparently the result of phenolphthalein being in the amorphous state instead of the crystalline state.

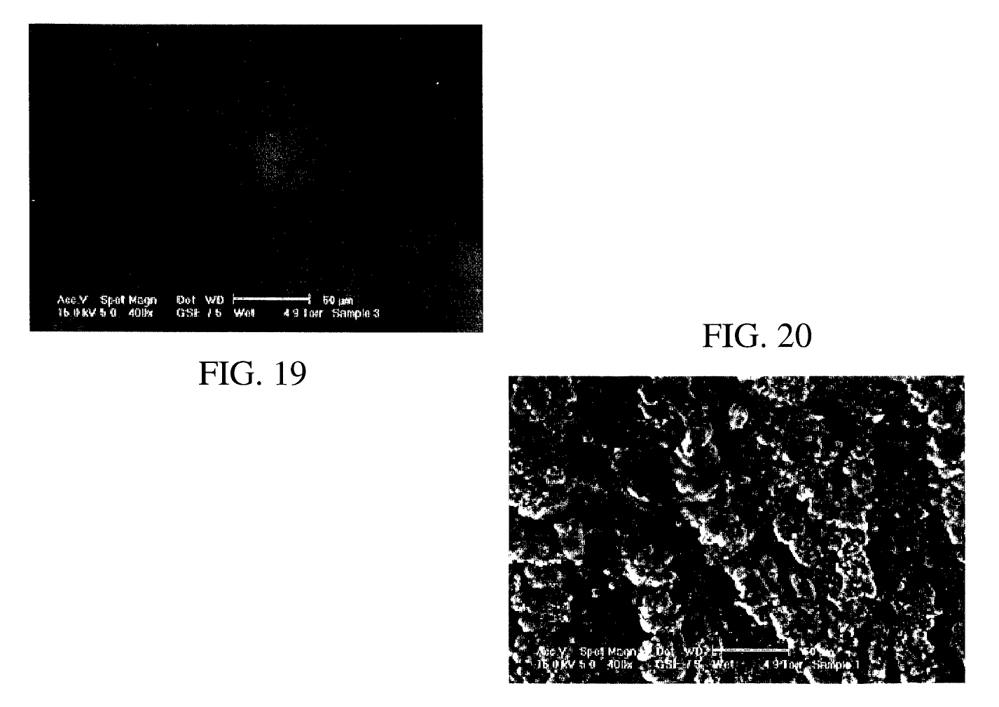

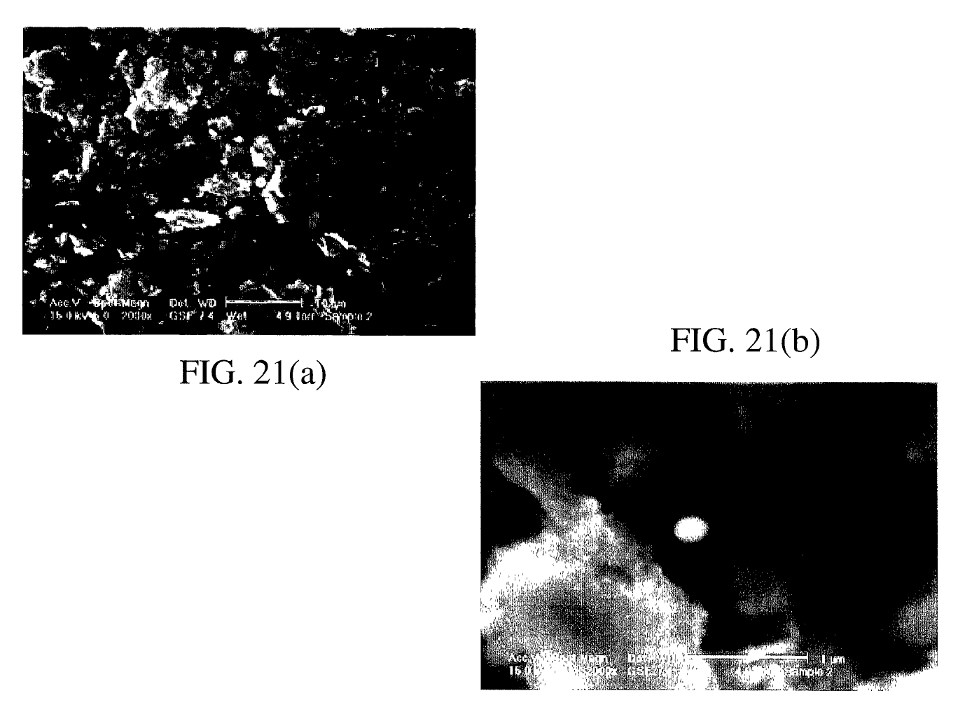

ESEM photographs are shown in FIGS. 19-21. For the pure agar gel of sample B shown in FIG. 19, distinct objects are not visible and the surface morphology of the gel is blurred. The agar gel is somewhat fragile. Therefore, it is not possible to obtain higher magnifications than that shown in the figures because a highly focused electron beam will damage the agar structure. With reference next to FIGS. 20 and 21(a), sample A2 is shown, which contains NaCl. Dendritic structures are clearly visible among the background of the amorphous agar. The crystallized dendrites are loosely connected and agar gel was present even the dendrites. Sample A2 contained phenolphthalein and is shown in FIG. 21(b). Small round particles, which are visible at high magnification, are present in the amorphous agar inside the crystallized NaCl dendrite. These small particles may be phenolphthalein precipitates that formed either during gelation processes, when water was consumed by the hydrolysis reaction, or during water evaporation out of the gel. Similar round features were found by atomic force microscopy (“AFM”) for acrylic polymer coating containing small phenolphthalein precipitate particles having approximately between 0.5 and 2.0 μm in diameter). From these observations, it is proposed that the agar gel, incorporating NaCl and phenolphthalein, consists of loosely connected NaCl dendrites that are distributed in the amorphous agar substrate. Additionally, small roundish-shaped phenolphthalein particles that have precipitated out of the gel solution are uniformly distributed throughout the gel. The agar-gel matrix probably contains a high or saturated concentration of dissolved NaCl and phenolphthalein, which is in equilibrium with the precipitated solid. Therefore, the gel is almost saturated with phenolphthalein and NaCl. The purpose of applying the gel on a bare aluminum alloy surface is to detect the pH increase associated with the cathodic reactions accompanying corrosion. The high saturation of phenolphthalein and NaCl is expected to provide an effective corrosion detection capability in accordance with the present invention.

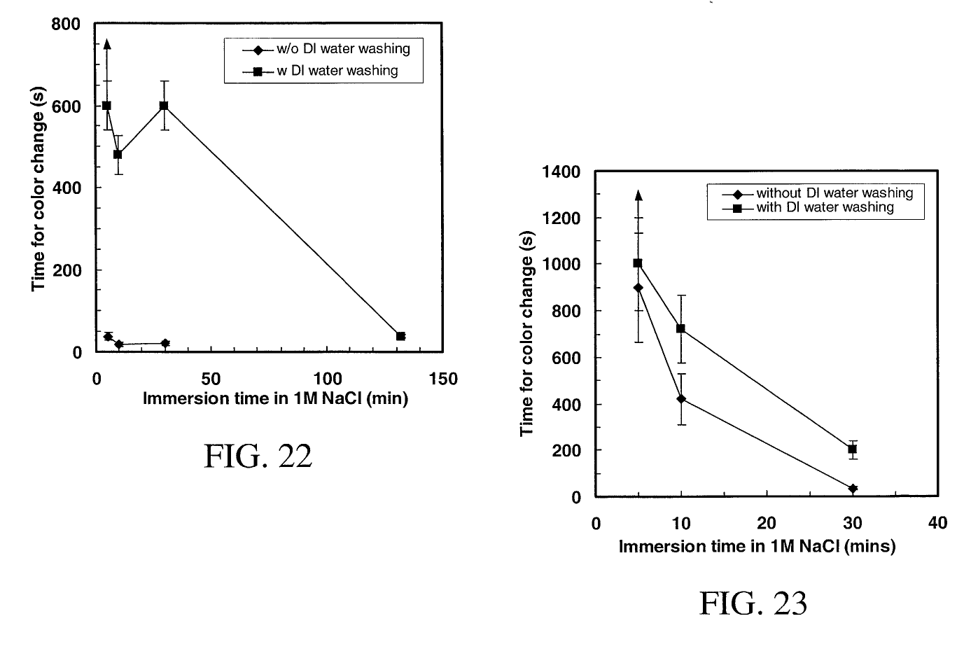

Corrosion sensing properties were evaluated by the time for initial color change time (“TICC”) after application of the modified agar-gel on the sample surface. This is similar to the previously described procedure used with the corrosion sensing acrylic coatings described earlier. For phenolphthalein modified agar-gel systems, the TICC is plotted against the prior immersion time in a 1M NaCl solution. See, for example, FIGS. 22-25. Almost all of the samples that were rinsed with deionized (“DI”) water after immersion in the 1M NaCl solution showed much longer TICC compared to samples tested without post-immersion DI water rinsing. As can be understood with reference to FIGS. 22, 23, and 24, the TICC decreased with increasing immersion time in 1M NaCl for gels without NaCl and for gels with NaCl and a low phenolphthalein content of approximately 0.05% by weight (“% wt.”). For the agar-gel system with NaCl and high phenolphthalein content of about 0.24% wt., the TICC was almost independent of the time of prior immersion, as can be seen with reference to FIG. 25. Gels having a high phenolphthalein content of about 0.24% wt. exhibited a very short TICC. This is especially true for samples that were not rinsed with DI water after immersion in the salt bath. Similarly, the presence of NaCl in the modified gel decreased the TICC.

With reference again to Table 3, it is apparent that the gel sample containing 7-hydroxycoumarin exhibited much shorter times for initial fluorescing behavior than the TICC for agar-gel systems containing phenolphthalein. In addition to the short time until fluorescing for the 7-hydroxycoumarin modified agar-gel, fluorescence was also observed for an as-polished sample. An “as-polished” sample refers to a clean sample that has just been polished and that has not yet experienced any corrosion. In contrast, a pH indicating color change was not observed for phenolphthalein modified agar-gel unless the sample was immersed in the NaCl bath. The result from a titration test established that the critical pH value for the modified agar solution and gel matrix was equal to the value for the pure indicator compounds.

The corrosion detection sensitivity for polymer coatings containing pH indicators was shown to be primarily controlled by the pH sensing behavior. Therefore, the high sensitivity corrosion detection of the gel system modified with 7-hydroxycoumarin was anticipated due to its low critical pH. The fluorescence observed for gels containing 7-hydroxycoumarin on as-polished samples may be related to a small amount of corrosion that occurred during the polishing in water.

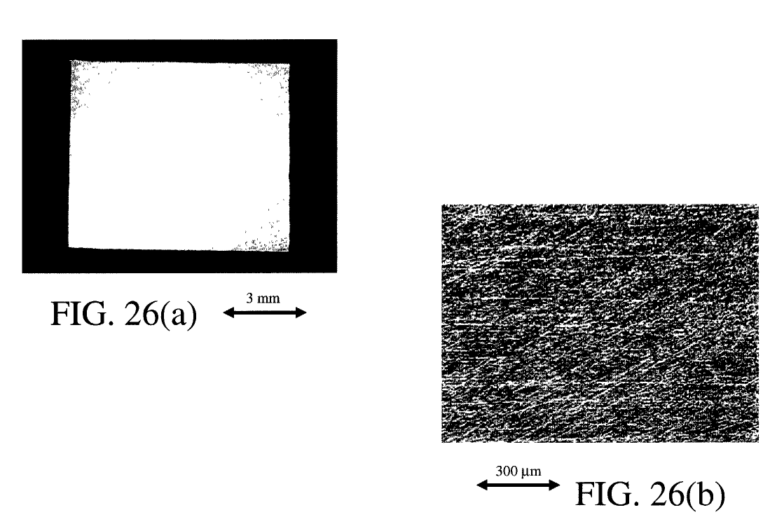

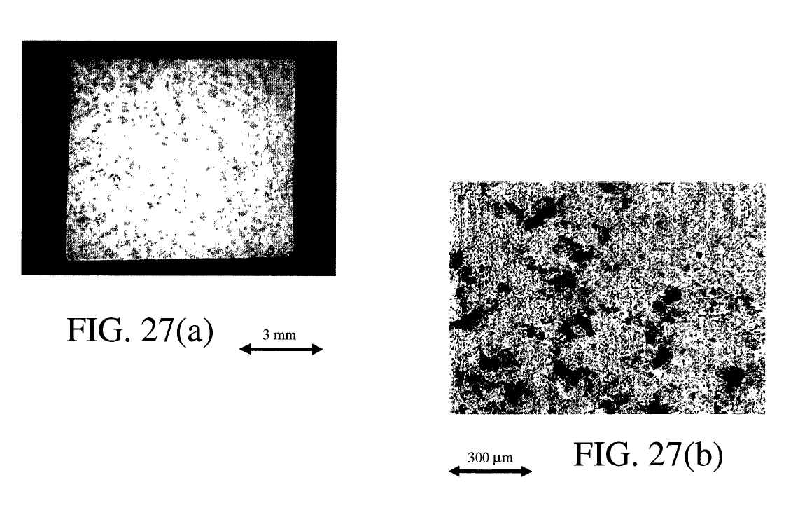

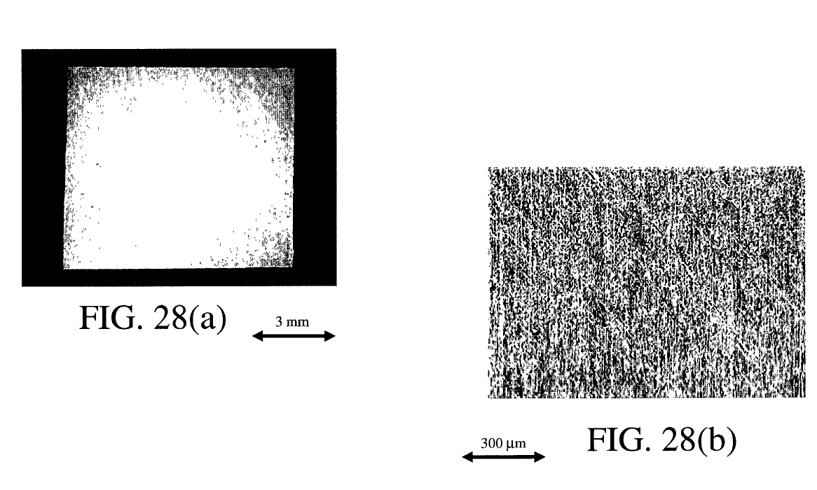

Next, the relationship between color change and corrosion is reviewed to confirm that the approach described previously for polymer paint can be applied to agar-gel systems. Reference is next made to FIGS. 26 through 30 in the following discussion of how the modified gel acts as a corrosion sensor. The surface of an as-polished aluminum alloy 2024-T3 sample is shown in FIGS. 26(a) and (b). The surface is unattacked, except for some small pits that formed during water polishing and which are visible in FIG. 26(b). FIG. 27 shows an aluminum alloy 2024-T3 sample coated by a modified gel containing 0.49% wt. agar, 0.24% wt. phenolphthalein, and 1.7 % wt. NaCl without prior immersion in 1M NaCl. This sample exhibited no sign of color change after 5 hours of immersion. The dark spots are due to the accumulation of agar-gel after drying. Reference is next made to FIG. 28. After the gel coating was rinsed off, the aluminum alloy surface exhibited the same ‘unattacked’ morphology that was seen prior to gel coating. That is, the presence of small pits is the only apparent feature. As can be appreciated by those with skill in the art, the metal sample or structure must not be corroded by the gel coating.

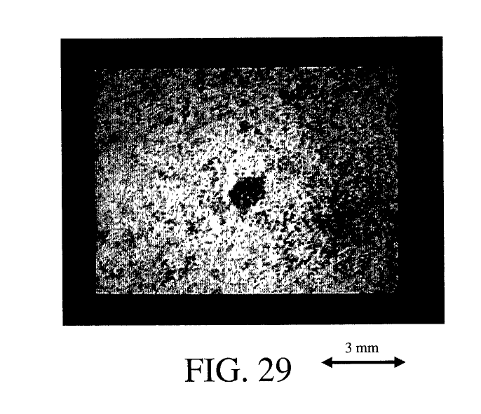

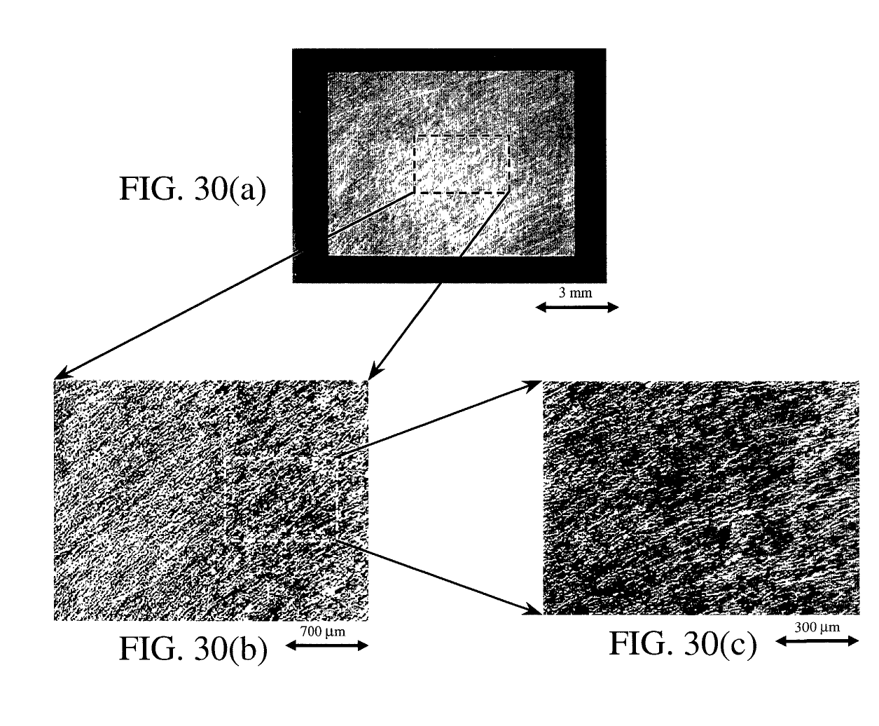

Distinct red color spots could be observed within 10 seconds after applying the modified agar-gel to the sample shown in FIG. 29, which had been pre-immersed in a 1M NaCl solution for 14 min before gel application. The red color was maintained by the gel for more than 10 hours and remained even after the gel coating dried. The gel coating on the sample of FIG. 29 is shown 4 hours after the gel coating was applied to the aluminum alloy. The right side of the sample exhibits a uniformly distributed red color. FIG. 30 shows the image of the sample of FIG. 29 after the gel coating was rinsed off. The surface is clearly corroded compared to as-polished surface shown in FIG. 26. There is a correlation between the color change location seen in FIG. 29 and the corroded areas indicated by dashed-line boxes in FIGS. 30(a), 30(b), and 30(c). There is a proximal correlation between the location of color change shown in FIG. 29 and the trench due to corrosion, as shown in FIG. 30(b) in the white dashed-line box. The zone of heavy attack shown in FIGS. 30(b) and 30(c) is directly associated with the center of the red region in FIG. 29.

Since the corrosion potential of the aluminum alloy 2024-T3 was far below the reversible potential of oxygen reduction and hydrogen evolution, cathodic reactions associated with corrosion result in pH increases that can in turn induce cathodic corrosion. So the region of color change might be associated with the location of cathodic dissolution for a sample surface previously immersed in a NaCl solution.

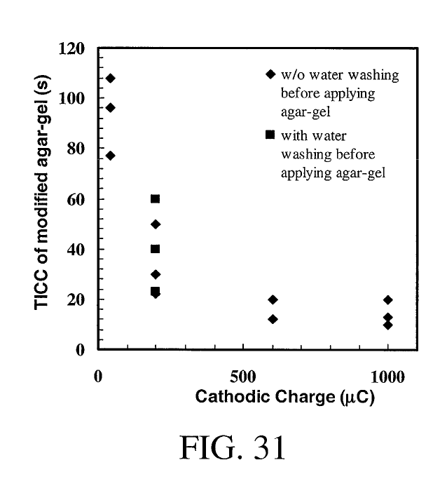

To confirm that pH increases cause color changes in the agar-gel, TICC was measured after gel coatings (0.49% wt. agar and 24% wt. phenolphthalein) were applied on aluminum alloy 2024-T3 samples that had previously been cathodically galvanostated to various charge densities before application of the gel. The results, as reflected in FIG. 22, indicate that TICC decreases with increasing cathodic charge and is apparently not influenced by whether or not the samples were washed with water after the cathodic treatment. The increase of accumulated OH— with increasing cathodic charge may be the reason for the shorter detection time. With reference to FIG. 22, one with skill in the art will see that this trend is similar to that shown in the results for prolonged immersion test using the same gel coating system. However, the small difference in TICC for samples with and without water washing after the cathodic treatment is different than the immersion experiments where water washing had a big effect. See, for example, FIG. 31. The color change of modified agar gel applied to corroded or cathodically-treated samples after rinsing is similar to observations reported by M. A. Alodan and W. H. Smyrl, J. Electrochem. Soc., 144, L282 (1997), and M. A. Alodan and W. H. Smyrl, J. Electrochem. Soc., 145, 1571 (1998). Alodan and Smyrl exposed aluminum alloys to chloride solutions containing fluorescein, a strong fluorescing dye or compound, and monitored the fluorescence with a confocal laser scanning microscope. Fluorescence was detected at certain intermetallic particles even after water washing.

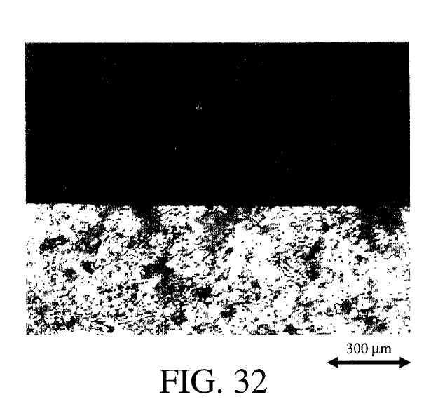

The influence of viscosity or mass transport properties of the modified gel on the corrosion sensing process was also evaluated. One observation was made with a modified agar gel that had not completed the gelling process. This modified gel was heated to 75° C. for 15 minutes. Using this gel, it was observed that the color change for the modified agar spread away from the corrosion site and beyond the edge of the aluminum alloy sample, and onto the epoxy mounting substrate. See, for example, FIG. 32. This may be evidence of the transport or diffusion out of the sample surface of either the alkaline form of phenolphthalein or of the OH— ion.

The color change extending beyond the edge of the aluminum alloy sample may also be attributed to the diffusion of the alkaline form of phenolphthalein with different structure than the neutral or acidic form. To confine the location of the color change strictly within the cathodic area, agar-gel with high viscosity and slow mass transport is preferably used. On the other hand, a certain amount of transport of hydrogen or chloride ion is necessary to accelerate the processes of corrosion in the previous corroded/anodic area and pH value increase in the previous cathodic area so as to improve the corrosion sensing ability of the gel coating. In reality, both of the above considerations are important to optimization of the overall properties of corrosion sensing accuracy and sensitivity.

The effect of gelling temperature and agar content on the gel properties are also important considerations in practicing the present invention. Four gels compositions with different contents were evaluated for this purpose and they are described in Table 4.1. The gels contained agar, NaCl, and phenolphthalein in the following compositions: 0.49% wt. agar, 0.24% wt. phenolphthalein, with or without 1.7% wt. NaCl, remainder water, and 0.49% wt. agar, 0.05 % wt. phenolphthalein, with or without 1.7% wt. NaCl, remainder water. The agar content of 0.49% wt. mixture was kept constant because of the gelling properties, which will be discussed below.

The effect of phenolphthalein content on the TICC can be explained by the fact that the pH sensing mechanism of the indicator in the modified agar-gel did not change after the gelling process. The functionality of an indicator, e.g. phenolphthalein, in agar-gel was shown above to be able to detect the pH increase associated with the cathodic part of a corrosion reaction. This has been illustrated in part by previous works including J. Colreavy and J. D. Scantlebury, Journal of Materials Processing Technology, 55, 206-212 (1995); and in the short film entitled “Corrosion in Action”, by The International Nickel Company, Inc., New York, N.Y., (1977). None of the prior works have suggested or disclosed the use of an agar gel with a phenolphthalein indicator to sense the presence and location of corrosion pitting on a structure. Instead, the prior efforts were more generally directed to demonstrations of the fundamental nature of cathodic corrosion principles.

The critical pH value for color change for the modified gel as determined by titration was the same as that of pure phenolphthalein and had a pH of about 10. From this result, it is assumed that the phenolphthalein and agar were physically blended after gelling. ESEM observation of phenolphthalein particles that had precipitated out of the gel provided additional information about the physical-blending phenomenon between indicator and agar-gel.

Gels with or without NaCl can sense corrosion by reacting with the high pH on the sample surface that is generated during the prior exposure to NaCl solution or bath. The response of chloride-containing gels is faster because they replicate the corrosive environment of the bath and thereby stimulate further attack. However, chloride-containing gels do not cause color change without the prior exposure to chloride solution. Therefore, these gels do not cause the corrosive attack, but rather stimulate the color-indicating response of the gel to pre-existing corrosion.

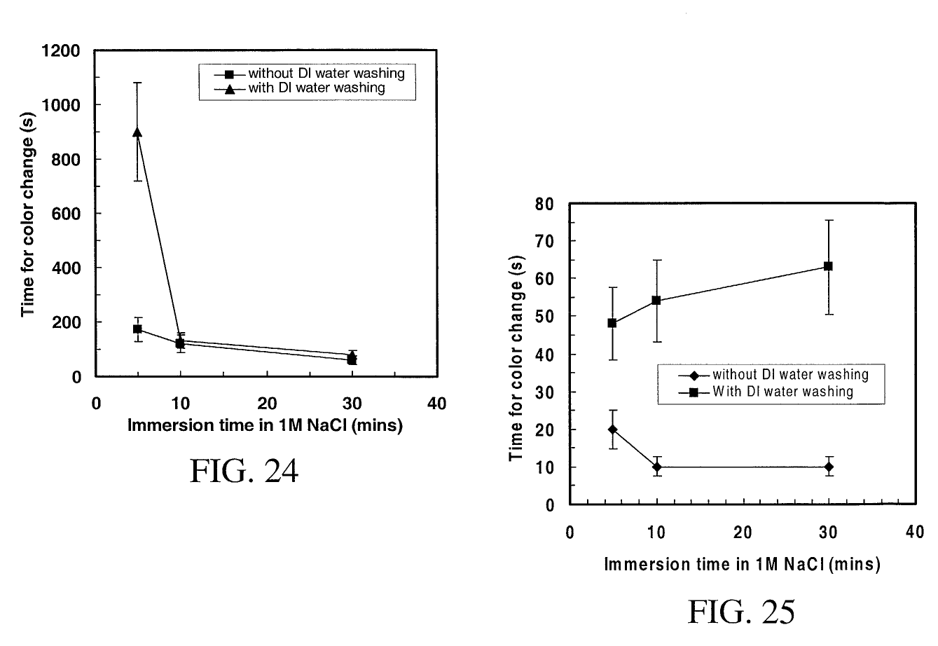

Water washing of the sample surface after immersion in 1M NaCl changed the surface condition in a way that neutralized the increased pH value associated with the cathodic reaction. As a result, the color changing or pH-sensing behavior of the modified agar-gel exhibits decreased intensity. Also, a longer response time is required before any color change is apparent. In contrast, the TICC does not decrease when NaCl-containing gels are used because the critical pH value of the modified agar-gel is maintained by the replication of previously established corrosion environment. With reference to FIGS. 24 and 25, it can be understood that the lack of dependence of TICC on immersion time is associated with the corrosion sensing limit (or the smallest amount of corrosion that was detectable) of the NaCl-containing gel system.

One of the limitations of this technique is that the localized corrosion can not be initiated in an accurately controlled manner. For samples with corrosion initiated by applying an anodic current of 100 μA for between about 1 and 5 minutes. This is a sufficient amount of time to generate localized corrosion so that a color change in the applied gel will be uniformly observed across the sample surface. This is in contrast to the localized spots observed for the modified acrylic polymer sensing coatings discussed previously.

The consistency and transparency of the modified gel coating directly impacts its color change property. Gels with high agar content (greater than about >3.3% wt.) did not form smooth, transparent coatings due to the large size of agar particles that formed in suspension. In comparison, agar-based coatings having a low agar content (less than about 1.0% wt.) formed very smooth and highly transparent coatings, which resulted in an easily distinguishable color change associated with pitting corrosion.

For phenolphthalein modified gel coating with about 1.7% wt. NaCl and 3.3% wt. agar, the color spots on the gel coating disappeared within about 2 to 4 hours. This is attributed to the high agar content of the gel, which increases the rate of the drying process and the gelling and melting temperatures. See, for example, M.-F. Lai and C.-y. Lii, International Journal of Biological Macromolecules, 21, 123-130 (1997). Gelling temperature (T_{GEL}) is the temperature at which the gel structural networks initiate through formation of helices and junction zones during cooling. Melting temperature (T_{M}) is the temperature related to the dissociation of highly cross-linked junction zones of the gel networks during heating. See, for example, Id. and V. E. Donohue, F. McDonald, and R. Evans, Journal of Applied Biomaterials, 6, 69-74 (1995). The agar content of a gel has been found to affect its thermal stability and the gel formation processes. Suspensions with very low agar content (less than about 0.1% wt.) did not form a gel, even after prolonged heating of about 4 hours at about 80 to 95° C. Gels having less than about 0.2% wt. of agar content are unstable and even when stored at room temperature, they will decompose and lose the gel properties within about a week. Re-heating to between about 80 and 95° C. and then cooling will not produce a gel reformation. This is true whether or not water is added. On the other hand, the high agar content gel having greater than about 0.49% wt. does not change even after being stored for about 2 months while exposed to air at room temperature. Additionally, this composition of agar gel maintains its pH sensing properties without degradation. In a controlled humidity environment, the color change of the modified agar gel due to corrosion has been demonstrated to last longer and up to at least several days. This demonstration establishes the relationship between corrosion sensing behavior and the above-described modified agar-gel properties. FIGS. 33(a) and 33(b) describe the dependence of T_{GEL} and T_{M} on agar concentration. See also, M.-F. Lai and C.-y. Lii, International Journal of Biological Macromolecules, 21, 123-130 (1997). T_{GEL} values of about 30° C. and 15° C. are predicted for agar contents of about 0.5 and 0.2% wt., respectively. This prediction corresponds well with observations of gel stability.

After water spraying a dried gel coating containing phenolphthalein and a high agar content, red spots reappeared at the locations on the sample where the color change originated. However, this phenomenon was not observed for low agar content gels having less than about 0.5% wt. agar content. This is because the gel coating itself was washed off. It was also found that, during heating, the suspension containing phenolphthalein changed color to light red, from the light yellow that is the color of agar mixture suspension. It was further observed that the red color disappeared upon gel formation and cooling to the room temperature. Although the subsequent neutralization process after cooling down to room temperature is unclear, the red color during heating may be due to hydrolysis during gel formation. See, for example, R. Falshaw, R. H. Furneaux, D. E. Stevenson, Carbohydrate Research, 308,107-115 (1998).

The pH value of agar suspension and agar gel was found to be between about 6.5 and 7.0 before and after heating, which is consistent with the yellow color of the gel or suspension at room temperature. In fact, it was reported that, in the processes of isolation of polysaccharide from seaweed or during the alkali treatment of native agar, the intermediate solution was buffered at pH 6.8. See, Id. However, there is no clear explanation in the literature for a pH increase during gelling processes at high temperatures between about 80 and 95° C. One possibility is that hydroxyl groups from the methylated position such as at G-6 or LA2 were substituted by various O-linked groups, thereby leaving the solution alkaline during the heating processes. See, Id. In any case, it is suggested that the color change or fluorescing behavior of the modified gel coating upon application to a sample surface was not associated with the gel pH value. Instead the color change or fluorescing behavior was induced by the pH increase associated with cathodic corrosion processes. To verify this, all types of gel compositions used in this work were smeared on clean, glass slides and no color change or fluorescing behavior was observed during a 24-hour observation period. In contrast, during the same time period, color changes were observed on agar gel-coated and corroded aluminum samples.

Several conclusions based upon the preceding discussion will be apparent to those with ordinary skill in the art regarding gel formation process, gel structure, and the corrosion sensing behavior on aluminum alloy 2024-T3 for a modified agar gel. First, Gel can be formed by blending a suitable pH indicator such as, for example, phenolphthalein, or a fluorescing compound, such as, for example, 7-hydroxycoumarin, and/or NaCl with agar under heating and cooling processes. The content of the selected agar, gel-forming agent, must be controlled so that the modified gel has good film forming ability and optical properties for corrosion detection.

Next, the modified gel demonstrates a sensitivity to corrosion processes by indicating a color change or a fluorescing responsive to UV radiation in close proximity to the corroded area. Third, the effect of indicator content and NaCl presence has been demonstrated for various gel compositions after prolonged immersion in corrosion inducing baths of 1M NaCl. This effect is apparent for samples whether or not they have been washed with water prior to application of the gel. Gels having relatively higher pH indicator content and the presence of NaCl reduce the TICC after gel coating application.

Lastly, inspection of the various modified gel compositions by optical microscopy, XRD, and ESEM revealed other important aspects of the present invention. For example, precipitation out of the gel solution of the indicator, such as phenolphthalein, after water evaporation may lead to corrosion detection by sensing pH increase associated with cathodic processes.

In sum, gel-coating-based corrosion sensing is an effective, easy, non-destructive, and economic resourceful technique. While preferred embodiments of the invention have been illustrated and described in detail, it will be within the ability of one skilled in the material corrosion arts to make modifications in the details of construction and application of the present invention, such as through the substitution of equivalent materials and parts and the arrangement of parts, or the application of equivalent process steps, without departing from the spirit of the invention and the scope of the following claims.

What is claimed is:

1. A composition for detecting corrosion of a material surface, said composition comprising:
an aqueous gel, adapted as a coating for a surface of a material, that includes at least one composition that changes its appearance in response to corrosion occurring on the surface of the material.

2. A composition according to claim 1 wherein the at least one composition is adapted to change color in response to a change in hydrogen ion concentration proximate to the surface of the material.

3. An aircraft prepared for corrosion inspection, the aircraft including a material surface that bears a coating, the coating comprising a removable corrosion-detecting substance that changes its appearance in response to corrosion occurring on the surface.

4. An aircraft prepared for corrosion inspection according to claim 3, wherein the composition comprises an aqueous gel that includes at least one composition that changes its appearance in response to corrosion occurring on the material surface.

5. An aircraft prepared for corrosion inspection according to claim 4 wherein the at least one composition is selected from the group consisting of substances that change color in response to a change in hydrogen ion concentration proximate to the material surface.

6. A vehicle prepared for corrosion inspection, the vehicle including a material surface bearing a coating, the coating comprising a removable corrosion detecting substance that changes its appearance in response to corrosion occurring on the surface.

7. A vehicle prepared for corrosion inspection according to claim 6, wherein the coating comprises an aqueous gel that includes at least one composition that changes its appearance in response to corrosion occurring on the material surface.

8. A vehicle prepared for corrosion inspection according to claim 7 wherein the at least one composition is selected from the group consisting of substances the change color in response to a change in hydrogen ion concentration proximate to the material surface.

9. A composition for detecting corrosion of a material surface, said composition comprising:
an aqueous gel, adapted as a coating for a surface of a material, that includes at least one composition that changes its appearance in response to corrosion occurring on the surface of the material.

10. An aircraft prepared for corrosion inspection, the aircraft including a material surface that bears a coating, the coating comprising a removable corrosion-detecting substance that changes its appearance in response to corrosion occurring on the surface.

11. A method of detecting corrosion of a material surface, said method comprising the steps of:
(a) selecting a material having a surface subject to corrosion;
(b) applying to the surface a removable corrosion-detecting substance that changes its appearance in response to corrosion occurring on the surface of the material;
(c) determining whether the appearance of the substance changed so as to indicate the presence of corrosion; and
(d) removing the substance from the surface.

12. A method of detecting corrosion of a surface of a material that bears a coating, said method comprising the steps of:
(a) obtaining a material having a surface subject to corrosion, the surface bearing a coating;
(b) removing the coating from the surface;
(c) applying to the surface a removable corrosion-detecting substance that changes its appearance in response to corrosion occurring on the surface of the coated material;
(d) determining whether the appearance of the substance changed so as to indicate the presence of corrosion; and
(e) removing the substance from the surface.

13. A method according to claim 12 wherein the corrosion-detecting substance comprises an aqueous gel that includes at least one composition that changes its appearance in response to corrosion occurring on the surface of the material.

14. A method according to claim 13 wherein the at least one composition is selected from the group consisting of substances adapted to change color in response to a change in hydrogen ion concentration proximate to the surface of the material.

15. A method according to claim 12 additionally comprising the step of reapplying the coating to the surface following removal of the corrosion detecting substance.

16. A method according to claim 12 wherein the coating is a paint.

17. A method according to claim 13 wherein the coating is a paint.

18. A method of detecting corrosion of an aircraft surface, the method comprising the steps of:
(a) selecting an aircraft having a surface subject to corrosion and bearing a coating;
(b) removing the coating from the surface;
(c) applying to the surface a removable corrosion-detecting substance that changes its appearance in response to corrosion occurring on the surface;
(d) determining whether the appearance of the substance changed its appearance so as to indicate the presence of corrosion; and
(e) removing the substance from the surface.

19. A method according to claim 18 wherein the corrosion-detecting substance comprises an aqueous gel that includes at least one composition adapted to change its appearance in response to corrosion occurring on the surface.

20. A method according to claim 18 wherein the at least one composition is selected from the group consisting of substances adapted to change color in response to a change in hydrogen ion concentration proximate to the surface.

21. A method according to claim 18 additionally comprising the step of reapplying the coating to the surface following removal of the corrosion detecting substance from the surface.

22. A method according to claim 18 wherein the coating is a paint.

23. A method according to claim 21 wherein the coating is a paint.
